(19) United States
(12) Patent Application Publication
(10) Pub. No.: US 2026/0040225 A1
(43) Pub. Date: Feb. 5, 2026

(54) VOICE SPEAKING-LISTENING BASED ADAPTIVE SCHEDULING

(71) Applicant: Apple Inc., Cupertino, CA (US)

(72) Inventors: Lijie ZHANG, Beijing (CN); Zhiwei WANG, Beijing (CN); Lakshmi N. KAVURI, San Jose, CA (US)

(73) Assignee: Apple Inc., Cupertino, CA (US)

(21) Appl. No.: 18/998,324

(22) PCT Filed: Jul. 25, 2022
(86) PCT No.: PCT/CN2022/107657

§ 371 Date: Jan. 24, 2025

(51) Int. Cl. H04W 52/02; H04W 76/28

(52) U.S. Cl. CPC H04W 52/0241; H04W 52/0216; H04W 76/28

(57) ABSTRACT

Some aspects of this disclosure relate to apparatuses and methods for implementing mechanisms for configuring Connected Mode Discontinuous Reception (CDRX) and resource allocation. For example. a user equipment (UE) includes a transceiver configured to enable wireless communication with a base station and a processor. The processor is configured to receive, using the transceiver and from the base station, a message indicating whether a downlink (DL) voice packet is to be transmitted to the UE. The processor is further configured to determine whether the UE is transmitting an uplink (UL) voice packet. In response to the message indicating that no DL voice packet is to be sent to the UE and a determination that no UL voice packet is to be transmitted to the base station. the processor is configured to refrain from starting a discontinuous reception (DRX) timer and to transition the UE to a sleep mode.

### BACKGROUND

### Field

The described aspects generally relate to mechanisms for a network to configure scheduling for transmission and reception of voice packets.

### Related Art

During a voice communication (e.g., a voice call), two user equipments (UEs) transmit and receive voice packets through a base station (for example, an evolved Node B (eNB), a next generation Node B (gNB)). When a first UE has voice packets to transmit, the first UE has to be in an awake mode to transmit the voice packets. The second UE has to be in the awake mode to receive the transmitted voice packets. In conventional methods, a pre-scheduling method can be used for the first UE to transition to the awake mode for uplink (UL) transmission to reduce latency. Also, the first UE can use a scheduling request when the first UE has UL voice packets. Because of the conflict between the pre-scheduling and the scheduling request, the first UE transitions to the awake mode twice resulting in the UE's additional power consumption. Similarly, in conventional methods, the second UE transitions to the awake mode based on a predetermined schedule even if there are no downlink (DL) voice packets to receive.

### SUMMARY

Some aspects of this disclosure relate to apparatuses and methods for implementing mechanisms for configuring Connected Mode Discontinuous Reception (CDRX) and resource allocation.

Some aspects of this disclosure relate to a user equipment (UE). The UE includes a transceiver configured to enable wireless communication with a base station and a processor communicatively coupled to the transceiver. The processor is configured to receive, using the transceiver and from the base station, a message indicating whether a downlink (DL) voice packet is to be transmitted to the UE. The processor is further configured to determine whether the UE is transmitting an uplink (UL) voice packet. In response to the message indicating that no DL voice packet is to be sent to the UE and a determination that no UL voice packet is to be transmitted to the base station, the processor is configured to refrain from starting a discontinuous reception (DRX) timer and to transition the UE to a sleep mode.

In some aspects, the processor is further configured to transition the UE from the sleep mode to an active mode before receiving the message from the base station. In some aspects, the processor is configured to transition the UE from the sleep mode to the active mode before an scheduled Connected Mode DRX (CDRX) OnDuration window.

In some aspects, the message includes a wake up signal (WUS) having a bit set to a first value to indicate that no DL voice packet is to be transmitted to the UE. In some aspects, the WUS includes a downlink control information (DCI) format with cyclic redundancy check (CRC) bits that are scrambled by a power saving radio network temporary identifier (PS-RNTI).

In some aspects, the processor is further configured to determine that no DL voice packet is to be transmitted to the UE, determine that the UL voice packet is to be transmitted to base station, and use an immediate next Scheduling Request (SR) occasion to send an SR signal for transmitting the UL voice packet.

In some aspects, the processor is further configured to determine that the DL voice packet is to be transmitted to the UE and determine that the UL voice packet is to be transmitted to base station. The processor is further configured to use an Scheduling Request (SR) occasion immediately before an scheduled Connected Mode DRX (CDRX) OnDuration window to send an SR signal for transmitting the UL voice packet.

In some aspects, the processor is further configured to determine that the DL voice packet is to be transmitted to the UE and determine that the UL voice packet is to be transmitted to base station. The processor is further configured to use an Scheduling Request (SR) occasion immediately after a downlink control information (DCI) format with cyclic redundancy check (CRC) bits that are scrambled by a power saving radio network temporary identifier (PS-RNTI) (DCP) occasion to send an SR signal for transmitting the UL voice packet.

In some aspects, the processor is further configured to determine that the DL voice packet is to be transmitted to the UE and in response to not receiving the DL voice packet during an scheduled Connected Mode DRX (CDRX) OnDuration window, extend the CDRX OnDuration window.

Some aspects of this disclosure relate to a method including receiving, by a user equipment (UE) and from a base station, a message indicating whether a downlink (DL) voice packet is to be transmitted to the UE and determining whether the UE is transmitting an uplink (UL) voice packet. In response to the message indicating that no DL voice packet is to be sent to the UE and a determination that no UL voice packet is to be transmitted to the base station, the method further includes refraining from starting a discontinuous reception (DRX) timer and transitioning the UE to a sleep mode.

Some aspects of this disclosure relate to a non-transitory computer-readable medium storing instructions. When the instructions are executed by a processor of a user equipment, the instructions cause the processor to perform operations including receiving, by the UE and from a base station, a message indicating whether a downlink (DL) voice packet is to be transmitted to the UE and determining whether the UE is transmitting an uplink (UL) voice packet. In response to the message indicating that no DL voice packet is to be sent to the UE and a determination that no UL voice packet is to be transmitted to the base station, the operations further include refraining from starting a discontinuous reception (DRX) timer and transitioning the UE to a sleep mode.

Some aspects of this disclosure relate to a base station. The base station includes a transceiver configured to enable wireless communication with a user equipment (UE) and a processor communicatively coupled to the transceiver. The processor is configured to determine whether an uplink (UL) voice state of the UE is in an active mode. In response to determining that the UL voice state is in the active mode, the processor can configure a Connected Mode discontinuous reception (CDRX) to an ON mode. In response to determining that the UL voice state is in a silent mode, the processor can configure the CDRX to the ON mode for DRX cycles associated with Silence Insertion Descriptor (SID) packets and can configure the CRDX to an OFF mode for other DRX cycles of the CDRX.

In some aspects, the processor is further configured to monitor a plurality of Medium Access Control (MAC) Protocol Data Units (PDUs) of a plurality of voice packets and determine a number of the plurality of MAC PDUs that do not include a logical identifier (ID). In response to the determined number being greater than a threshold, the processor can determine that the UL voice state is in the silent mode.

In some aspects, the processor is further configured to monitor a MAC PDU of a second voice packet received after the plurality of voice packets and determine that the MAC PDU of the second voice packet includes a second logical ID. The processor can further determine that the UL voice state is in the active mode in response to the determination that the MAC PDU of the second voice packet includes the second logical ID.

In some aspects, the processor is further configured to determine a number of pre-scheduled Physical Uplink Shared Channel (PUSCH) occasions during which no UL packets are received at the base station. In response to the determined number being greater than or equal to a threshold, the processor can determine that the UL voice state is in the silent mode.

Some aspects of this disclosure relate to a method including determining whether an uplink (UL) voice state of the UE is in an active mode. In response to determining that the UL voice state is in the active mode, the method includes configuring a Connected Mode discontinuous reception (CDRX) to an ON mode. In response to determining that the UL voice state is in a silent mode, the method includes configuring the CDRX to the ON mode for DRX cycles associated with Silence Insertion Descriptor (SID) packets and can configure the CRDX to an OFF mode for other DRX cycles of the CDRX.

Some aspects of this disclosure relate to a non-transitory computer-readable medium storing instructions. When the instructions are executed by a processor of a base station, the instructions cause the processor to perform operations including determining whether an uplink (UL) voice state of the UE is in an active mode. In response to determining that the UL voice state is in the active mode, the operations include configuring a Connected Mode discontinuous reception (CDRX) to an ON mode. In response to determining that the UL voice state is in a silent mode, the operations include configuring the CDRX to the ON mode for DRX cycles associated with Silence Insertion Descriptor (SID) packets and can configure the CRDX to an OFF mode for other DRX cycles of the CDRX.

This Summary is provided merely for purposes of illustrating some aspects to provide an understanding of the subject matter described herein. Accordingly, the above-described features are merely examples and should not be construed to narrow the scope or spirit of the subject matter in this disclosure. Other features, aspects, and advantages of this disclosure will become apparent from the following Detailed Description, Figures, and Claims.

### BRIEF DESCRIPTION OF THE FIGURES

The accompanying drawings, which are incorporated herein and form part of the specification, illustrate the present disclosure and, together with the description, further serve to explain the principles of the disclosure and enable a person of skill in the relevant art(s) to make and use the disclosure.

FIG. 1A illustrates an example system implementing mechanisms for a network to implement mechanisms for configuring Connected Mode Discontinuous Reception (CDRX) and resource allocation, according to some aspects of the disclosure.

FIG. 1B illustrates an exemplary voice communication between two UEs, according to some aspects of the disclosure.

FIG. 2 illustrates a block diagram of an example system of an electronic device implementing mechanisms for configuring CDRX for DL reception and resource allocation for UL transmission, according to some aspects of the disclosure.

FIGS. 3A-3C illustrate exemplary power diagrams for configuring Connected Mode Discontinuous Reception (CDRX) for downlink (DL) transmission, according to some aspects of the disclosure.

FIGS. 4A-4B illustrate exemplary power diagrams for configuring resource allocation for UL transmission, according to some aspects of the disclosure.

FIG. 5A illustrates an exemplary power diagrams for a UE in an UL active mode, according to some aspects of this disclosure

FIG. 5B illustrates an exemplary power diagrams for a UE in an UL silent mode with SID packets, according to some aspects of this disclosure

FIG. 5C illustrates an exemplary power diagrams for a UE in an UL silent mode, according to some aspects of this disclosure.

FIG. 6 illustrates an exemplary diagram for enhanced Physical Downlink Control Channel (PDCCH) monitoring with a wake up signal (WUS), according to some aspects of this disclosure.

FIG. 7 illustrates an exemplary system for down-sampling Connected Mode Discontinuous Reception (CDRX) cycle using WUS, according to some aspects of this disclosure.

FIG. 8 illustrates an example method for a system (for example, a UE) supporting mechanisms for configuring CDRX and resource allocation, according to some aspects of the disclosure.

FIG. 9 illustrates an example method for a system (for example, a base station) supporting mechanisms for configuring CDRX and resource allocation, according to some aspects of the disclosure.

FIG. 10 is an example computer system that can be used for implementing some aspects or portion(s) thereof.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

Some aspects of this disclosure relate to apparatuses and methods for implementing mechanisms for configuring Connected Mode Discontinuous Reception (CDRX) for downlink (DL) and resource allocation for uplink (UL).

In some examples, the aspects of this disclosure can be performed by a network and/or a UE that operates according to new radio (NR) of 5^{th} generation (5G) wireless technology for digital cellular networks as defined by 3rd Generation Partnership Project (3GPP). Additionally, or alternatively, the aspects of this disclosure can be performed by a network and/or a UE that operates according to the Release 17 (Rel-17), Release 16 (Rel-16), and Release 15 (Rel-15), or others. However, the aspects of this disclosure are not limited to these examples, and one or more mechanisms of this disclosure can be implemented by other network(s) and/or UE(s) for using CDRX configuration and resource allocation to enhance UE's power consumption and enhance physical resource usage.

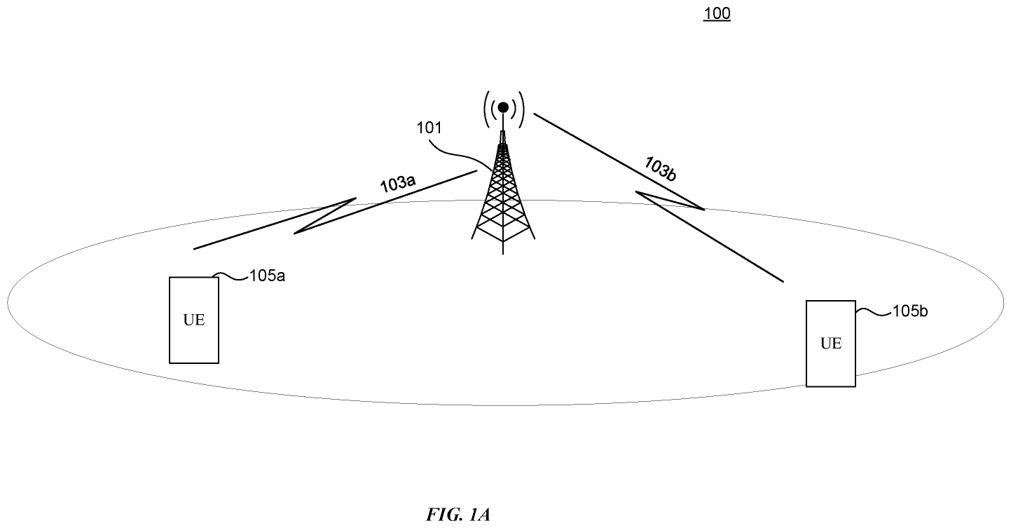

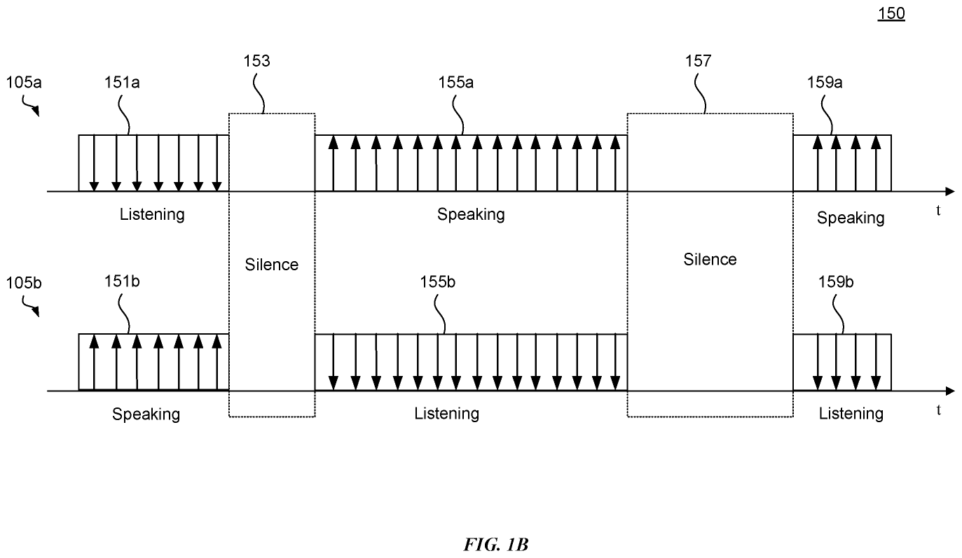

FIG. 1A illustrates an example system 100 implementing mechanisms for configuring Connected Mode Discontinuous Reception (CDRX) for and resource allocation, according to some aspects of the disclosure. Example system 100 is provided for the purpose of illustration only and does not limit the disclosed aspects.

System 100 may include, but is not limited to, a base station 101 (for example, a base stations such as eNBs, gNBs, and the like) and electronic devices (for example, a UE) 105a and 105b. The electronic devices 105a and 105b (hereinafter referred to as UE 105) can include an electronic device configured to operate based on a wide variety of wireless communication techniques. These techniques can include, but are not limited to, techniques based on 3rd Generation Partnership Project (3GPP) standards. For example, the UE 105 can include an electronic device configured to operate using NR, Rel-17, and/or other releases of 3GPP standards. The UE 105 can include, but is not limited to, as wireless communication devices, smart phones, laptops, desktops, tablets, personal assistants, monitors, televisions, wearable devices, Internet of Things (IoTs), vehicle's communication devices, and the like. The base station 101 (herein referred to as base station or cell) can include nodes configured to operate based on a wide variety of wireless communication techniques such as, but not limited to, techniques based on 3GPP standards. For example, the base station 101 can include nodes configured to operate using NR, Rel-17, and/or other releases of 3GPP standards.

According to some aspects, the UE 105 can be connected to and can be communicating with the base station 101 using a carrier 103 (the carrier 103 herein refers to carriers 103a and 103b collectively). According to some aspects, the carrier 103 can include one carrier. Additionally, or alternatively, the carrier 103 can include two or more component carriers (CC). In other words, the UE 105 can implement carrier aggregation (CA). For example, the UE can use multiple carriers for communication with the base station 101.

According to some aspects, the UE 105a can communicate voice packets with the UE 105b. In some examples, the voice packets can be part of a voice call between the UE 105a and the UE 105b. In some examples, the voice packets can be part of a video call between the UE 105a and the UE 105b. Although some examples are discussed with respect to voice packets, the aspects of this disclosure are not limited to these packets can be applied to other types of packets communicated between the UE 105a and the UE 105b.

In some conventional methods, the base station 101 can design a schedule of periodic and pre-defined grant instances for UL transmission for some type of traffic such as regular traffic (e.g., voice over internet protocol (VoIP)). In some examples, this schedule of periodic and pre-defined grant instances can include semi-persistent scheduling. For example, the schedule of periodic and pre-defined grant instances can include semi-persistent scheduling (SPS) in Long Term Evolution (LTE) and/or Configured Grant (CG) in NR. In some examples, in the (SPS) resource allocation, the base station 105 can allocate at least a part of resources and transport formats to the UE semi-statically over a certain time interval. In some examples, the use of CG for UL transmission can eliminate the need to request and assign resources for each packet transmission by pre-allocating resources to the UE 105.

In some conventional methods, the base station 101 can allocate periodic but dynamic physical resources for UL transmission to the UE 105 before the UE 105 sends Scheduling Requests (SRs) and/or Buffer Status Reporting (BSR) to reduce latency. In some examples where the periodic but dynamic physical resources are allocated, the UE 105 can skip SR transmission and wait for the allocated resources. In some implementations, the allocated resources can include resources during the CDRX OnDuration windows.

These conventional methods provide challenges for the base station 101 and/or the UE 105. For example, on the UE 105 side, periodic voice packets arrival at the UE 105 triggers period schedule requests before the CDRX OnDuration windows. On the base station 101 side, the base station 101 not only allocates UL grant based on SRs from the UE 105, the base station 101 also pre-schedules UL grants in, for example, each CDRX OnDuration window periodically. Therefore, the UE 105 is using additional power because it wakes up (transitions to the awake mode) twice, one time for transmitting SR and one time during the CDRX OnDuration window.

Another challenge for the base station 101 and/or the UE 105 in these conventional method is power consumption even though both UEs 105a and 105b are silent. With the CDRX configured, the UE 105 has to wake up during the CDRX OnDuration windows to monitor potential UL and/or DL scheduling. Therefore, the UE 105 is using additional power because it has to wake up (transition to the awake mode) even though neither of UEs 105a and 105b has packets to transmit.

The aspect of this disclosure address the challenges discussed above by implementing mechanisms for configuring CDRX for downlink (DL) and resource allocation for uplink (UL).

FIG. 1B illustrates an exemplary voice communication 150 between two UEs, according to some aspects of the disclosure. As illustrated in FIG. 1B, during time period 151a, the user of the UE 105a is listening (e.g., in a listening mode or a DL active mode) and during similar time period 151b, the UE 105b is speaking (e.g., in a speaking mode or UL active mode). Similarly, during time period 155a, the user of the UE 105a is speaking (e.g., in the speaking mode or the UL active mode) and during similar time period 155b, the UE 105b is listening (e.g., in the listening mode or DL active mode). Also, during time period 159a, the user of the UE 105a is speaking (e.g., in the speaking mode or the UL active mode) and during similar time period 159b, the UE 105b is listening (e.g., in the listening mode or DL active mode).

As illustrated in FIG. 1B, the during time periods 153 and 157, the user of the UE 105a and the user of the UE 105b are silent (e.g., the silent mode). According to some aspects, the silence time period 153 (as one example of the silence time periods 153 and 157) can include an UL silence where no voice packets are transmitted. Additionally, or alternatively, the silence time period 153 can include an UL silence mode where Silence Insertion Descriptor (SID) packets (e.g., background noise) are transmitted. According to some aspects, the silence time period 153 (as one example of the silence time periods 153 and 157) can include a DL silence mode where no voice packets are received. Additionally, or alternatively, the silence time period 153 can include a DL silence mode where SID packets (e.g., background noise) are received.

As discussed in more detail below, according to some aspects during the listening mode (or the DL active mode) SR and pre-scheduling are not used. In this mode, one time wake up in the CDRX OnDuration window can be used and the UE 105 can transition to the sleep mode earlier after the DL reception. According to some aspects, in the speaking mode (or the UL active mode), CDRX OnDuration window is not used and SR based UL grant is used. According to some aspects, during the silent mode where no UL or DL packets are transmitted, the UE 105 can stay in the sleep mode and does not transition to the awake mode. Additionally, or alternatively, during the silent mode where no UL or DL packets are transmitted, the UE 105 can stay in the awake mode for a short period of time and transition to the sleep mode quickly.

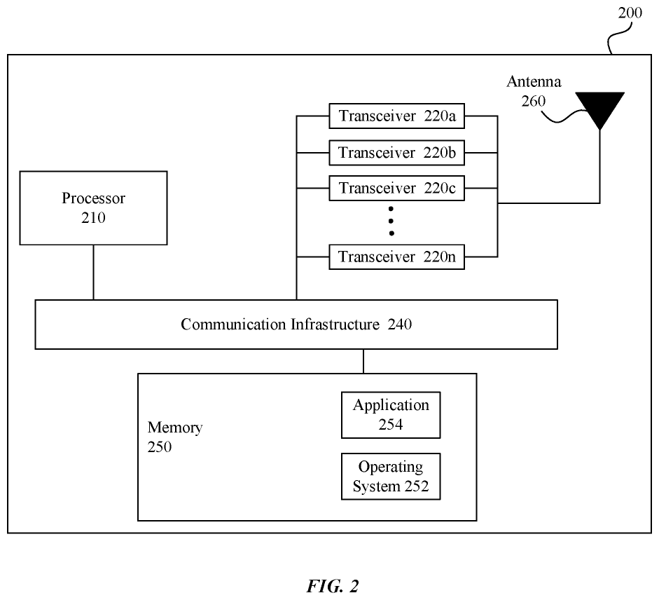

FIG. 2 illustrates a block diagram of an example system 200 of an electronic device implementing mechanisms for configuring CDRX and resource allocation, according to some aspects of the disclosure. System 200 may be any of the electronic devices (e.g., the base station 101, the UE 105) of system 100. The system 200 (e.g., a wireless system) includes at least a processor 210, one or more transceivers 220a-220n, a communication infrastructure 240, a memory 250, an operating system 252, an application 254, and an antenna 260. Illustrated systems are provided as exemplary parts of the system 200, and the system 200 can include other circuit(s) and subsystem(s). Also, although the systems of the system 200 are illustrated as separate components, the aspects of this disclosure can include any combination of these, fewer, more, and/or different components.

The memory 250 may include random access memory (RAM) and/or cache, and may include control logic (e.g., computer software) and/or data. The memory 250 may include other storage devices or memory such as, but not limited to, a hard disk drive and/or a removable storage device/unit. According to some examples, the operating system 252 can be stored in the memory 250. The operating system 252 can manage transfer of data from the memory 250 and/or one or more applications 254 to the processor 210 and/or one or more transceivers 220a-220n. In some examples, the operating system 252 maintains one or more network protocol stacks (e.g., Internet protocol stack, cellular protocol stack, and the like) that can include a number of logical layers. At corresponding layers of the protocol stack, the operating system 252 includes control mechanism and data structures to perform the functions associated with that layer.

According to some examples, the application 254 can be stored in the memory 250. The application 254 can include applications (e.g., user applications) used by the system 200 and/or a user of the system 200. The applications in application 254 can include applications such as, but not limited to, audio streaming, video streaming, remote control, and/or other user applications.

The system 200 can also include the communication infrastructure 240. The communication infrastructure 240 provides communication between, for example, the processor 210, one or more transceivers 220a-220n, and the memory 250. In some implementations, the communication infrastructure 240 may be a bus. The processor 210 together with instructions stored in the memory 250 performs operations enabling the system 200 of system 100 to implement mechanisms for configuring CDRX for DL reception and resource allocation for UL transmission, as described herein. Additionally, or alternatively, the one or more transceivers 220a-220n perform operations enabling the system 200 of system 100 to implement mechanisms for configuring CDRX for DL

The one or more transceivers 220a-220n transmit and receive communications signals that support mechanisms for configuring CDRX for DL reception and resource allocation for UL transmission, according to some aspects, and may be coupled to the antenna 260. The antenna 260 may include one or more antennas that may be the same or different types. The one or more transceivers 220a-220n allow the system 200 to communicate with other devices that may be wired and/or wireless. In some examples, the one or more transceivers 220a-220n can include processors, controllers, radios, sockets, plugs, buffers, and like circuits/devices used for connecting to and communication on networks. According to some examples, the one or more transceivers 220a-220n include one or more circuits to connect to and communicate on wired and/or wireless networks.

According to some aspects, the one or more transceivers 220a-220n can include a cellular subsystem, a WLAN subsystem, and/or a Bluetooth™ subsystem, each including its own radio transceiver and protocol(s) as will be understood by those skilled arts based on the discussion provided herein. In some implementations, the one or more transceivers 220a-220n can include more or fewer systems for communicating with other devices.

In some examples, the one or more transceivers 220a-220n can include one or more circuits (including a WLAN transceiver) to enable connection(s) and communication over WLAN networks such as, but not limited to, networks based on standards described in IEEE 802.11. Additionally, or alternatively, the one or more transceivers 220a-220n can include one or more circuits (including a Bluetooth™ transceiver) to enable connection(s) and communication based on, for example, Bluetooth™ protocol, the Bluetooth™ Low Energy protocol, or the Bluetooth™ Low Energy Long Range protocol. For example, the transceiver 220n can include a Bluetooth™ transceiver.

Additionally, the one or more transceivers 220a-220n can include one or more circuits (including a cellular transceiver) for connecting to and communicating on cellular networks. The cellular networks can include, but are not limited to, 3G/4G/5G networks such as Universal Mobile Telecommunications System (UMTS), Long-Term Evolution (LTE), and the like. For example, the one or more transceivers 220a-220n can be configured to operate according to one or more of Rel-15, Rel-16, Rel-17, NR, or other of the 3GPP standards.

According to some aspects, the processor 210, alone or in combination with computer instructions stored within the memory 250, and/or the one or more transceiver 220a-220n, implements mechanisms for configuring CDRX for DL reception and resource allocation for UL transmission, as discussed herein.

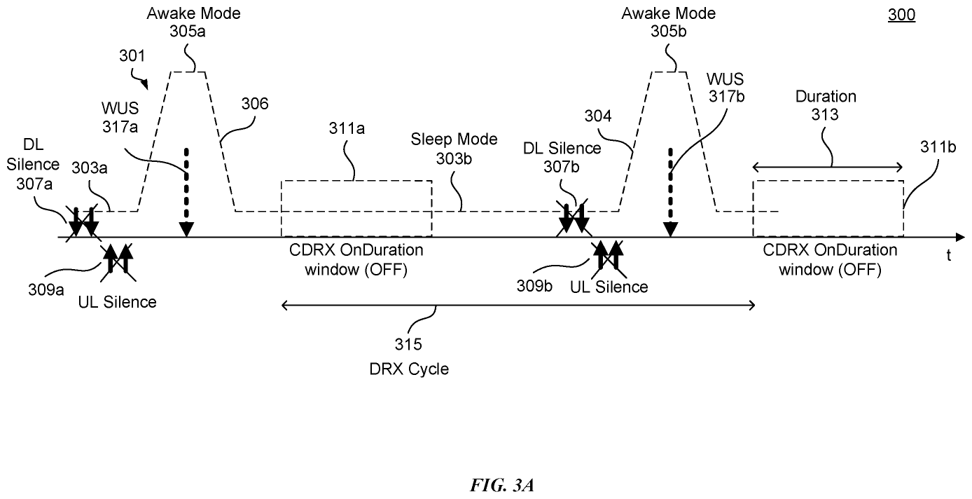

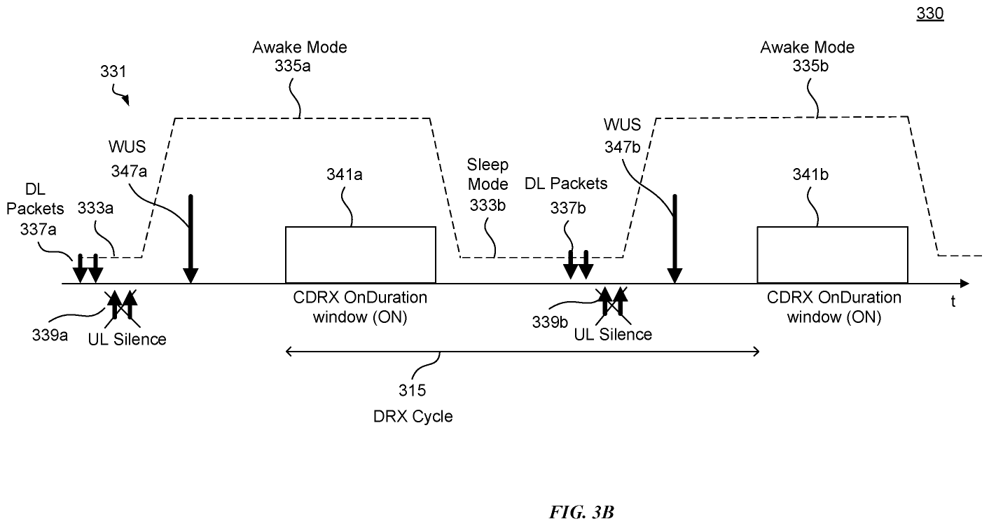

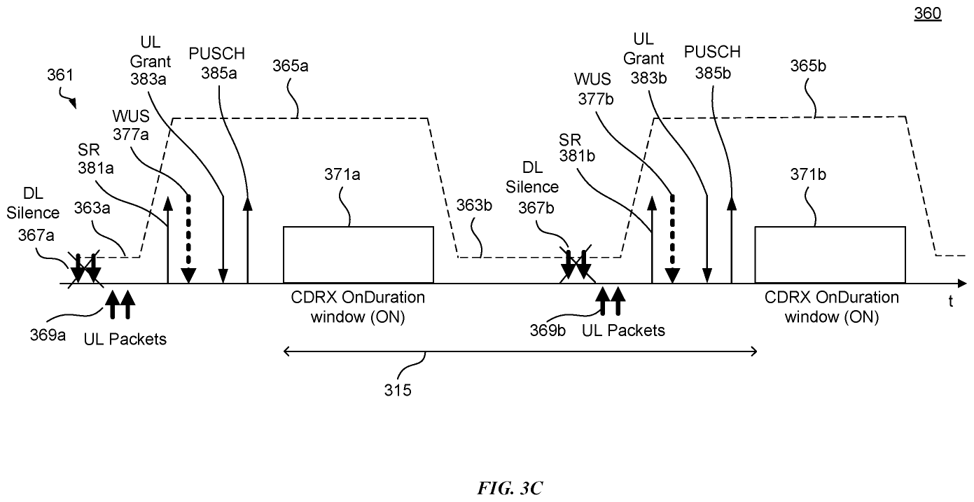

FIGS. 3A-3C illustrate exemplary power diagrams for configuring Connected Mode Discontinuous Reception (CDRX) for downlink (DL) transmission, according to some aspects of the disclosure.

FIG. 3A illustrates an exemplary power diagram 300 for a case where the users of both UEs (e.g., the user of the UE 105a and the user of the UE 105b) are silent (e.g., the silent mode). This case can also be referred to as DL silence and UL silence. The power diagram 300 illustrates a power wave 301 that indicates different power mode of a UE (e.g., the UE 105) during time.

FIG. 3A also illustrates CDRX OnDuration windows 311a and 311b (also referred to collectively as CDRX OnDuration window 311). As discussed in more detail below, in the DL silence and UL silence of FIG. 3A, the CDRX OnDuration will be in an OFF mode.

According to some aspects, DRX is a mechanism that lets the UE 105 to be in the sleep mode for a first period of time and lets the UE 105 to be in the awake mode for a second period of time. The network (e.g., the base station 101) can communicate the parameters of the DRX operation (e.g., the timings and periods for the sleep mode and the awake mode) to the UE 105. In some examples, the network (e.g., the base station 101) can use Radio Resource Control (RRC) message(s) (e.g., RRC connection setup and/or reconfiguration) to communicate the parameters of the DRX operation to the UE 105. In some examples, DRX Cycle (e.g., the duration of one “ON time” plus one “OFF time”) and DRX on duration timer (e.g., the duration of “ON time” within one DRX cycle) are some of the parameters of the DRX operation. FIG. 3A illustrates the DRX Cycle 315 between the beginnings of two consecutive CDRX OnDuration windows 311a and 311b. Additionally, FIG. 3a illustrates the duration 313 of the CDRX OnDuration window 311 (e.g., the DRX on duration timer (e.g., the duration of “ON time” within one DRX cycle)).

According to some aspects, the UE is configured to transition from the sleep mode 303a to the awake mode 305a and start its DRX on duration timer before the scheduled CDRX OnDuration window 311a in order to receive any Physical Downlink Control Channel (PDCCH) signals from the network (e.g., the base station 101) during CDRX OnDuration window 311a and/or to receive any UL grant messages from the network during the awake mode 305a and/or the CDRX OnDuration window 311a. According to some aspects, the transitions from the sleep modes (e.g., sleep mode 303a) to the awake modes (e.g., the awake mode 305a) are based on the pre-scheduled CDRX OnDuration window (e.g., the CDRX OnDuration window 311a). In the exemplary DL silence and UL silence case of FIG. 3A, the UE does not have any UL packets (309a and 309b-UL silence mode) to transmit to the base station. Similarly, the base station does not have any DL packets (307a and 307b-DL silence mode) to transmit to the UE.

According to some aspects, since the UE does not have UL packets to transmit, the UE does not send any SR signals to the base station and the UE does not expect to receive any UL grant messages from the base station. Additionally, the base station can send a message 317a (or 317b) to the UE to indicate to the UE that no DL packets will be transmitted during the CDRX OnDuration window 311a (or 311b). After receiving the message 317a (or 317b), the UE can determine that no DL packets are to transmitted (307a and 307b-DL silence mode).

In these implementations, the UE can transition from the sleep mode 303a (or 303b) to the awake mode 305a (305b) before the scheduled CDRX OnDuration window 311a (or 311b). During the transition to the awake mode 305a (or 305b) and/or during the awake mode 305a (or 305b), the UE can receive the message 317a (or 317b) indicating the no DL packets are to be transmitted from the base station to the UE. Based on the message 317a (or 317b), the UE will not start its DRX on duration timer and will transition to the sleep mode 303b. Accordingly, the UE can save power and reduce power consumption by transitioning to the sleep mode earlier than scheduled.

According to some aspects, the message 317 (referred to the collection of messages 317a and 317b) can include a wake up signal (WUS). In some examples, the WUS can include a downlink control information (DCI) format with cyclic redundancy check (CRC) bits that are scrambled by a power saving radio network temporary identifier (PS-RNTI). According to some examples, the WUS can include a frame header, an address field, a payload/command field, and a Cyclic Redundancy Check (CRC)/Frame Check Sequence (FCS) field. In some examples, one or more bits in the WUS can be set to a first value (e.g., “1”) to indicate that DL packets are to be transmitted from the base station to the UE. For example, the base station can set the one or more bits in the WUS can be set to the first value. The one or more bits in the WUS can be set to a second value (e.g., “0”) to indicate that no DL packets are to be transmitted from the base station to the UE. For example, the base station can set the one or more bits in the WUS can be set to the second value.

FIG. 3B illustrates an exemplary power diagram 330 for a case where the user of one UE (e.g., UE 105a) is speaking (e.g., in the speaking mode or the UL active mode) and the user of the other UE (UE 105b) is listening (e.g., in the listening mode or the DL active mode). The power diagram 330 illustrates a power wave 331 that indicates different power mode of a UE (e.g., the UE 105b) during time. The UE associated with the power diagram 330 is in the listening mode or the DL active mode. This case can also be referred to as DL active and UL silence for the UE.

FIG. 3B also illustrates CDRX OnDuration windows 341a and 341b (also referred to collectively as CDRX OnDuration window 341). As discussed in more detail below, in the DL active and UL silence of FIG. 3B, the CDRX OnDuration will be in ON mode.

According to some aspects, the UE is configured to transition from the sleep mode 333a to the awake mode 335a and start its DRX on duration timer before the scheduled CDRX OnDuration window 341a in order to receive any Physical Downlink Control Channel (PDCCH) signals from the network (e.g., the base station 101) during the CDRX OnDuration window 341a and/or to receive any UL grant messages from the network during the awake mode 335a and/or the CDRX OnDuration window 341a. According to some aspects, the transitions from the sleep modes (e.g., sleep mode 333a) to the awake modes (e.g., the awake mode 335a) are based on the pre-scheduled CDRX OnDuration window (e.g., the CDRX OnDuration window 341a). In the exemplary DL active and UL silence case of FIG. 3B, the UE does not have any UL packets (339a and 339b-UL silence mode) to transmit to the base station. However, the base station has DL packets (337a and 337b-DL active mode) to transmit to the UE.

According to some aspects, since the UE does not have UL packets to transmit, the UE does not send any SR signals to the base station and the UE does not expect to receive any UL grant messages from the base station. In the example of FIG. 3B, the base station can send a message 347a (or 347b) to the UE to indicate to the UE that the base station has DL packets to transmit during the CDRX OnDuration window 341a (or 341b). After receiving the message 347a (or 347b), the UE can determine that DL packets are to transmitted from the base station (337a and 337b-DL active). According to some aspects, the DL packets (337a and 337b) are transmitted from the base station to the UE during the CDRX OnDuration windows 341a and 341b, respectively.

In these implementations, the UE can transition from the sleep mode 333a (or 333b) to the awake mode 335a (335b) before the scheduled CDRX OnDuration window 341a (or 341b). During the transition to the awake mode 335a (or 335b) and/or during the awake mode 335a (or 335b), the UE can receive the message 347a (or 347b) indicating the DL packets are to be transmitted from the base station to the UE. Based on the message 347a (or 347b), the UE will start its DRX on duration timer and will remain in the awake mode 335a (or 335b). After the duration of the CDRX OnDuration window 341a (or 341b), the UE transitions to the sleep mode 333b. In other words, after the DRX on duration timer of the UE reaches a predetermined threshold, the UE transitions to the sleep mode 333b.

As discussed above, according to some aspects, the message 347 (referred to the collection of messages 347a and 347b) can include a wake up signal (WUS). In some examples, one or more bits in the WUS can be set to the first value (e.g., “1”) to indicate that DL packets are to be transmitted from the base station to the UE.

FIG. 3C illustrates an exemplary power diagram 360 for a case where the user of one UE (e.g., UE 105a) is speaking (e.g., in the speaking mode or the UL active mode) and the user of the other UE (UE 105b) is listening (e.g., in the listening mode or the DL active mode). The power diagram 360 illustrates a power wave 361 that indicates different power mode of a UE (e.g., the UE 105a) during time. The UE associated with the power diagram 360 is in the speaking mode or the UL active mode. This case can also be referred to as DL silence and UL active for the UE.

FIG. 3C also illustrates CDRX OnDuration windows 371a and 371b (also referred to collectively as CDRX OnDuration window 371). As discussed in more detail below, in the DL silence and UL active of FIG. 3C, the CDRX OnDuration will be in ON mode.

According to some aspects, the UE is configured to transition from the sleep mode 363a to the awake mode 365a and start its DRX on duration timer before the scheduled CDRX OnDuration window 371a in order to receive any Physical Downlink Control Channel (PDCCH) signals from the network (e.g., the base station 101) during the CDRX OnDuration window 371a and/or receive any UL grant messages from the network during the awake mode 365a and/or the CDRX OnDuration window 371a. According to some aspects, the transitions from the sleep modes (e.g., sleep mode 363a) to the awake modes (e.g., the awake mode 365a) are based on the pre-scheduled CDRX OnDuration window (e.g., the CDRX OnDuration window 371a). In the exemplary DL silence and UL active case of FIG. 3C, the UE has UL packets (369a and 369b-UL active mode) to transmit to the base station. However, the base station has no DL packets (367a and 367b-DL silence mode) to transmit to the UE.

According to some aspects, the base station can send a message 377a (or 377b) to the UE to indicate to the UE that the base station has no DL packets to transmit during the CDRX OnDuration window 371a (or 371b). After receiving the message 377a (or 377b), the UE can determine that no DL packets are to transmitted from the base station (367a and 367b-DL silence mode). As discussed above, according to some aspects, the message 377 (referred to the collection of messages 377a and 377b) can include a wake up signal (WUS). In some examples, one or more bits in the WUS can be set to the second value (e.g., “0”) to indicate that no DL packets are to be transmitted from the base station to the UE.

As illustrated in FIG. 3C, the UE has UL packets (369a or 369b) to transmit to the base station. In these implementations, the UE can transition from the sleep mode 363a (or 363b) to the awake mode 365a (365b) before the scheduled CDRX OnDuration window 371a (or 371b). During the transition to the awake mode 365a (or 365b) and/or during the awake mode 365a (or 365b), the UE can send the SR signal 381a (or 381b—also referred to as SR message/packet). In some aspects, the UE sends the SR signal 381a (or 381b) to request a transmission schedule from the base station. In response to the SR signal 381a (or 381b), the base station can send the UL grant message 383a (or 383b) granting an uplink occasion to the UE for transmitting its UL packets (369a or 369b). For example, the UE can transmit its UL packets (369a or 369b) during Physical Uplink Shared Channel (PUSCH) 385a (or 385b).

Additionally, during the transition to the awake mode 365a (or 365b) and/or during the awake mode 365a (or 365b), the UE can receive the message 377a (or 377b) indicating the no DL packets are to be transmitted from the base station to the UE. After the duration of the CDRX OnDuration window 371a (or 371b), the UE transitions to the sleep mode 363b. In other words, after the DRX on duration timer of the UE reaches a predetermined threshold, the UE transitions to the sleep mode 363b.

According to some aspects, for uplink transmission, the network (e.g., the base station 101) can optionally configure pre-scheduling for UL transmission. In some implementations the network does not configure pre-scheduling. Alternatively, in some implementations, the network can configure the pre-scheduling, but the network can cancel the pre-scheduling based on UL signal quality. The uplink signal quality can include any signal quality measured by the network or the UE. In some examples, the UL signal quality can include, but is not limited to, missing SR signals.

According to some aspects, when the network has configured the pre-scheduling, the network can configure the CDRX to an ON mode for a UE when the UE is in the speaking mode (UL active mode). In these examples, one or more bits in the WUS can be set to the first value (e.g., “1”) to indicate that the CDRX is in the ON mode. Additionally, or alternatively, when the UE is in the UL silence mode, the network can configure the CDRX mode depending on whether the UE transmits no UL packets or the UE transmits Silence Insertion Descriptor (SID) packets (e.g., background noise). In these implementations the network can configure the CDRX to the ON mode for SID packets with a predetermined period. Additionally, the network can configure the CDRX to the OFF mode for other DRX cycles. In a non-limiting example, the network can configure the CDRX to the ON mode for every four other DRX Cycles and configure the CDRX to the OFF mode for the DRX Cycles in between. In a non-limiting example, the DRX Cycle (e.g., the duration of one “ON time” plus one “OFF time”—DRX Cycle 315) can be about 40 ms and include one CDRX OnDuration window. The network can configure the CDRX to the ON mode for every 160 ms for the SID packets. The network can configure the CDRX to the OFF mode between the ON mode CDRXs. According to some aspects, one or more bits in the WUS can be set to the second value (e.g., “0”) to indicate that the CDRX is in the OFF mode. When the CDRX is set to the OFF mode, the UE does not start it DRX on duration timer, according to some implementations.

According to some aspects, when the network has not configured the pre-scheduling and/or when the network has configured the CDRX to the OFF mode, the UE can use SR signal (as discussed above) for UL grant and UL transmission.

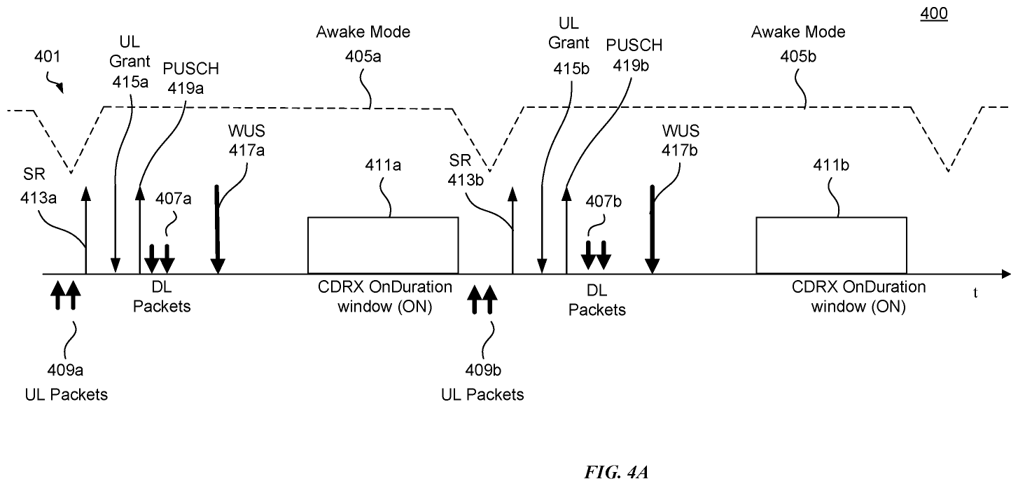

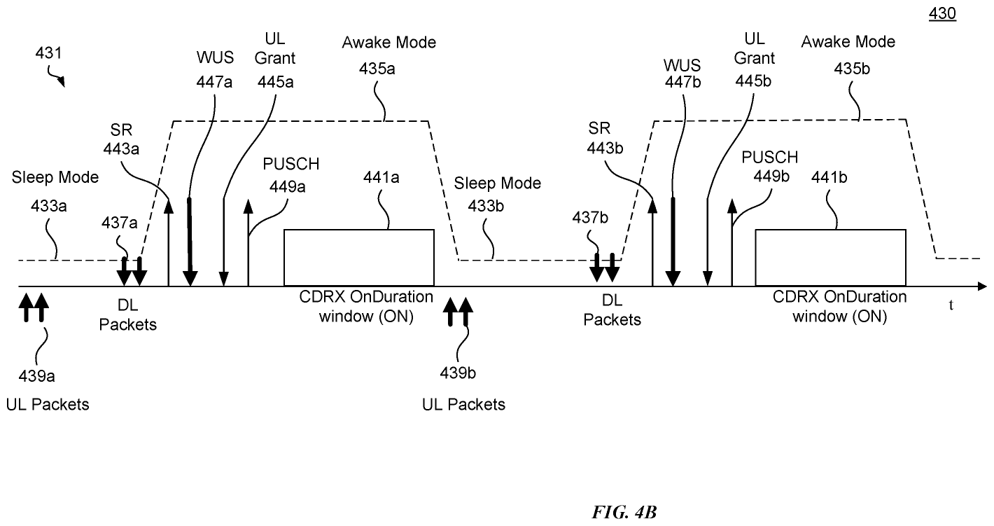

FIGS. 4A-4B illustrate exemplary power diagrams for configuring resource allocation for UL transmission, according to some aspects of the disclosure. According to some aspects, and as discussed above, a UE can use SR signal transmission to request for UL grant for UL transmission. According to some aspects, the UE can transmit the SR signal during SR occasions and when the UE has UL packets to transmit. In some implementations, the SR occasions occur periodically and are configured by the network.

FIG. 4A illustrates an exemplary power diagram 400 for a case where the user of one UE (e.g., UE 105a) is speaking (e.g., in the speaking mode or the UL active mode) and the user of the other UE (UE 105b) is also speaking (e.g., in the speaking mode or the UL active mode). The power diagram 400 illustrates a power wave 401 that indicates a different power mode of a UE (e.g., the UE 105a) during time. The UE associated with the power diagram 400 is in the speaking mode (the UL active mode) and also in the listening mode (the DL active mode). This case can also be referred to as DL active and UL active for the UE.

FIG. 4A also illustrates CDRX OnDuration windows 411a and 411b (also referred to collectively as CDRX OnDuration window 411). As discussed in more detail below, in the DL active and UL active of FIG. 4A, the CDRX OnDuration will be in ON mode.

According to some aspects, the UE is configured to transition from the sleep mode to the awake mode 405a and start its DRX on duration timer before the scheduled CDRX OnDuration window 411a in order to receive any Physical Downlink Control Channel (PDCCH) signals from the network (e.g., the base station 101) during the CDRX OnDuration window 411a and/or receive any UL grant messages from the network during the awake mode 405a and/or the CDRX OnDuration window 411a. According to some aspects, the transitions from the sleep modes to the awake modes (e.g., the awake mode 405a) are based on the pre-scheduled CDRX OnDuration window (e.g., the CDRX OnDuration window 411a). In the exemplary DL active and UL active case of FIG. 4A, the UE has UL packets (409a and 409b-UL active) to transmit to the base station. Also, the base station has DL packets (407a and 407b-DL active) to transmit to the UE. According to some aspects, the DL packets (407a and 407b) are transmitted from the base station to the UE during the CDRX OnDuration windows 411a and 411b, respectively.

According to some aspects, the base station can send a message 417a (or 417b) to the UE to indicate to the UE that the base station has DL packets to transmit during the CDRX OnDuration window 411a (or 411b). After receiving the message 417a (or 417b), the UE can determine that DL packets are to be transmitted from the base station (407a and 407b-DL active). As discussed above, according to some aspects, the message 417 (referred to the collection of messages 417a and 417b) can include a wake up signal (WUS). In some examples, one or more bits in the WUS can be set to the first value (e.g., “1”) to indicate that DL packets are to be transmitted from the base station to the UE.

As illustrated in FIG. 4A, the UE has UL packets (409a or 409b) to transmit to the base station. In these implementations, the UE can transition from the sleep mode to the awake mode 405a (or 405b) before the scheduled CDRX OnDuration window 411a (or 411b). During the transition to the awake mode 405a (or 405b) and/or during the awake mode 405a (or 405b), the UE can send the SR signal 413a (or 413b-also referred to as SR message/packet). In some aspects, the UE sends the SR signal 413a (or 413b) to request a transmission schedule for the UE from the base station. According to some aspects, the UE sends the SR signal 413a (or 413b) during SR occasions. In response to the SR signal 413a (or 413b), the base station can send the UL grant message 415a (or 415b) granting an uplink occasion to the UE for transmitting its UL packets (409a or 409b). For example, the UE can transmit its UL packets (409a or 409b) during Physical Uplink Shared Channel (PUSCH) 419a (or 419b).

In the example of FIG. 4A, the UE is selecting the immediate SR occasion for transmitting the SR signal 413a (or 413b). The immediate SR occasion is the SR occasion that is immediately after the receipt of the UL packets 409a (or 409b) at the UE's buffer(s) for UL transmission. In these examples, since the UE is selecting the immediate SR occasion, the UE is in the awake mode 405a (or 405b) for most of the time and does not transition to the sleep mode. Therefore, the UE can be wasting power during its UL transmission and/or DL reception.

FIG. 4B illustrates an exemplary power diagram 430 for another case where the user of one UE (e.g., UE 105a) is speaking (e.g., in the speaking mode or the UL active mode) and the user of the other UE (UE 105b) is also speaking (e.g., in the speaking mode or the UL active mode). The power diagram 430 illustrates a power wave 431 that indicates a different power mode of a UE (e.g., the UE 105a) during time. The UE associated with the power diagram 430 is in the speaking mode (the UL active mode) and also in the listening mode (the DL active mode). This case can also be referred to as DL active and UL active for the UE.

FIG. 4B also illustrates CDRX OnDuration windows 441a and 441b (also referred to collectively as CDRX OnDuration window 441). As discussed in more detail below, in the DL active and UL active of FIG. 4B, the CDRX OnDuration will be in ON mode.

According to some aspects, the UE is configured to transition from the sleep mode 433a to the awake mode 435a and start its DRX on duration timer before the scheduled CDRX OnDuration window 441a in order to receive any Physical Downlink Control Channel (PDCCH) signals from the network (e.g., the base station 101) during the CDRX OnDuration window 441a and/or receive any UL grant messages from the network during the awake mode 435a and/or the CDRX OnDuration window 441a. According to some aspects, the transitions from the sleep modes (e.g., sleep mode 433a) to the awake modes (e.g., the awake mode 435a) are based on the pre-scheduled CDRX OnDuration window (e.g., the CDRX OnDuration window 441a). In the exemplary DL active and UL active case of FIG. 4B, the UE has UL packets (439a and 439b—UL active) to transmit to the base station. Also, the base station has DL packets (437a and 437b—DL active) to transmit to the UE. According to some aspects, the DL packets (437a and 437b) are transmitted from the base station to the UE during the CDRX OnDuration windows 441a and 441b, respectively.

According to some aspects, the base station can send a message 447a (or 447b) to the UE to indicate to the UE that the base station has DL packets to transmit during the CDRX OnDuration window 441a (or 441b). After receiving the message 447a (or 447b), the UE can determine that DL packets are to transmitted from the base station (437a and 437b-DL active). As discussed above, according to some aspects, the message 447 (referred to the collection of messages 447a and 447b) can include a wake up signal (WUS). In some examples, one or more bits in the WUS can be set to the first value (e.g., “1”) to indicate that DL packets are to be transmitted from the base station to the UE.

As illustrated in FIG. 4B, the UE has UL packets (439a or 439b) to transmit to the base station. In these implementations, the UE can transition from the sleep mode 433a (or 433b) to the awake mode 435a (or 435b) before the scheduled CDRX OnDuration window 441a (or 441b). During the transition to the awake mode 435a (or 435b) and/or during the awake mode 435a (or 435b), the UE can send the SR signal 443a (or 443b—also referred to as SR message/packet). In some aspects, the UE sends the SR signal 443a (or 443b) to request a transmission schedule from the base station. According to some aspects, the UE sends the SR signal 443a (or 443b) during SR occasions. In response to the SR signal 443a (or 443b), the base station can send the UL grant message 445a (or 445b) granting an uplink occasion to the UE for transmitting its UL packets (439a or 439b). For example, the UE can transmit its UL packets (439a or 439b) during Physical Uplink Shared Channel (PUSCH) 449a (or 449b).

In the example of FIG. 4B, instead of selecting the immediate SR occasion for transmitting the SR signal 443a (or 443b) as discussed above with respect to FIG. 4A, the UE can select an SR occasion before or immediately before the UE starts its DRX on duration timer, according to some aspects. The selected SR occasion can be the SR occasion that is immediately before the UE starts its DRX on duration timer for CDRX OnDuration widow 441a. In these examples, since the UE is selecting the SR occasion immediately before the UE starts its DRX on duration timer, the UE can transition to the sleep mode 433b before the next SR occasion immediately before the UE starts its DRX on duration timer for CDRX OnDuration widow 441b.

In some implementations, the UE can select the SR occasion right after a downlink control information (DCI) format with cyclic redundancy check (CRC) bits that are scrambled by a power saving radio network temporary identifier (PS-RNTI) (DCP) slot/occasion. For example, the UE can select the SR occasion that is right after the DCP slot/occasion associated with message 447a (or 447b).

By selecting the SR occasion as discussed in FIG. 4B, the UE can be able to save power. In other words, by selecting the SR occasion as discussed in FIG. 4B, the UE can perform its UL transmissions and DL receptions close to each other and therefore, reducing power consumption.

According to some examples, if there are no DL packets are to be transmitted to the UE (DL silence mode), the UE can select the immediate SR occasion for transmitting the SR signal. The immediate SR occasion is the SR occasion that is immediately after the receipt of the UL packets at the UE's buffer(s) for UL transmission.

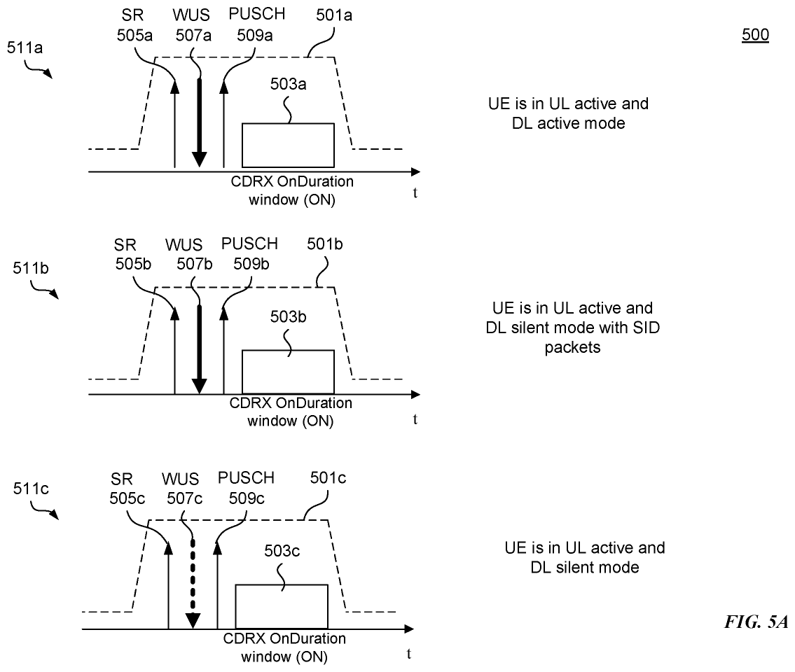

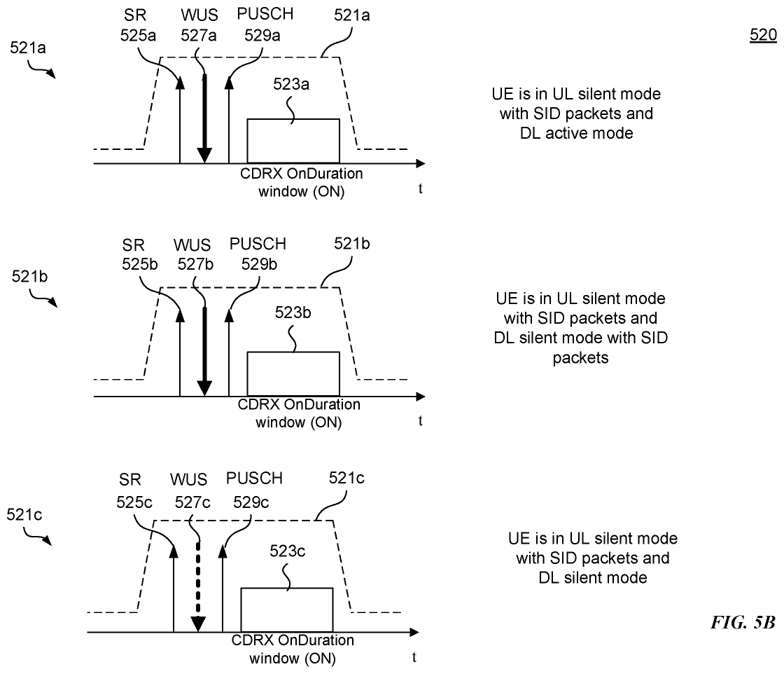

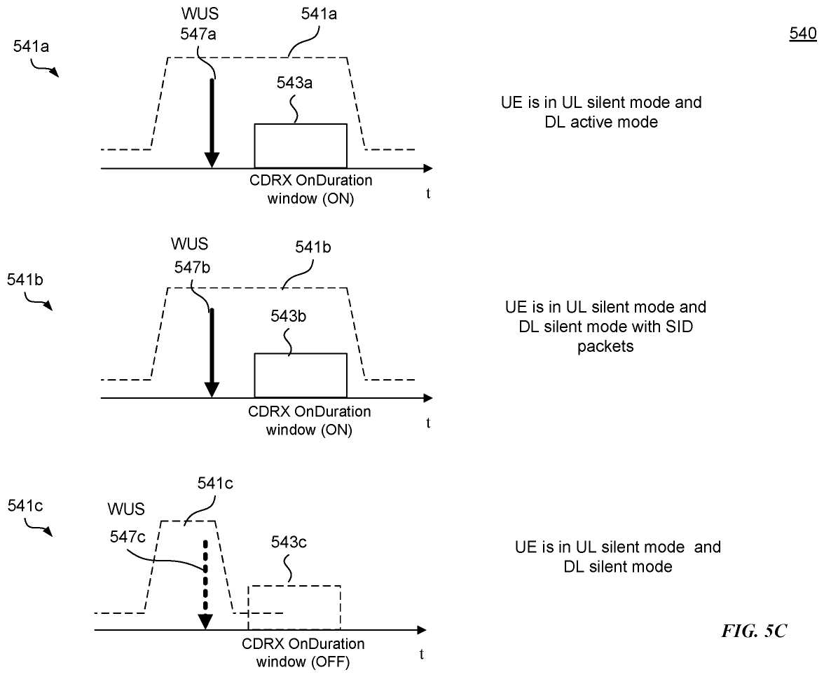

FIG. 5A illustrates an exemplary power diagrams 500 for a UE in an UL active mode, according to some aspects of this disclosure.

Power diagram 511a illustrates the UE's power diagram when the UE is in UL active and DL active mode. The UE is in the awake mode 501a that includes the CDRX OnDuration window 503a. During the transition to the awake mode 501a and/or during the awake mode 501a, the UE transmits the SR signal 505a for transmitting UL packets using PUSCH 509a. Although not shown, the UE can receive an UL grant message before transmitting the UL packets using PUSCH 509a. Additionally, during the transition to the awake mode 501a and/or during the awake mode 501a, the UE can receive message 507a indicating that the base station is to send DL packets. As discussed above, according to some aspects, the message 507a can include a wake up signal (WUS). In some examples, one or more bits in the WUS can be set to the first value (e.g., “1”) to indicate that DL packets are to be transmitted from the base station to the UE.

Power diagram 511b illustrates the UE's power diagram when the UE is in UL active and DL silent mode with SID packets. The UE is in the awake mode 501b that includes the CDRX OnDuration window 503b. During the transition to the awake mode 501b and/or during the awake mode 501b, the UE transmits the SR signal 505b for the transmitting UL packets using PUSCH 509b. Although not shown, the UE can receive an UL grant message before transmitting the UL packets using PUSCH 509b. Additionally, during the transition to the awake mode 501b and/or during the awake mode 501b, the UE can receive message 507b indicating that the base station is to send DL packets. In these examples, the DL packets can include SID packets. As discussed above, according to some aspects, the message 507b can include a wake up signal (WUS). In some examples, one or more bits in the WUS can be set to the first value (e.g., “1”) to indicate that DL packets are to be transmitted from the base station to the UE. In some aspects and as discussed above, the CDRX OnDuration window 503b is active (in the ON mode) in a predetermined cycle greater than the DRX cycle (e.g., DRX cycle 315). In a non-liming example, the CDRX OnDuration windows 503b are active every 160 ms compared to the DRX cycle of about 40 ms.

Power diagram 511c illustrates the UE's power diagram when the UE is in UL active and DL silent mode. In this example, in the DL silent mode no SID packets are received. The UE is in the awake mode 501c that includes the CDRX OnDuration window 503c. During the transition to the awake mode 501c and/or during the awake mode 501c, the UE transmits the SR signal 505c for the transmitting UL packets using PUSCH 509c. Although not shown, the UE can receive an UL grant message before transmitting the UL packets using PUSCH 509c. Additionally, during the transition to the awake mode 501c and/or during the awake mode 501c, the UE can receive message 507c indicating that the base station does not send any DL packets. As discussed above, according to some aspects, the message 507c can include a wake up signal (WUS). In some examples, one or more bits in the WUS can be set to the second value (e.g., “0”) to indicate that no DL packets are to be transmitted from the base station to the UE.

FIG. 5B illustrates an exemplary power diagrams 520 for a UE in an UL silent mode with SID packets, according to some aspects of this disclosure.

Power diagram 521a illustrates the UE's power diagram when the UE is in UL silent mode with SID packets and DL active mode. The UE is in the awake mode 521a that includes the CDRX OnDuration window 523a. During the transition to the awake mode 521a and/or during the awake mode 521a, the UE transmits the SR signal 525a for transmitting UL packets using PUSCH 529a. In these examples, the UL packets can be SID packets. Although not shown, the UE can receive an UL grant message before transmitting the UL packets using PUSCH 529a. Additionally, during the transition to the awake mode 521a and/or during the awake mode 521a, the UE can receive message 527a indicating that the base station is to send DL packets. As discussed above, according to some aspects, the message 527a can include a wake up signal (WUS). In some examples, one or more bits in the WUS can be set to the first value (e.g., “1”) to indicate that DL packets are to be transmitted from the base station to the UE. In some aspects and as discussed above, the CDRX OnDuration window 523a is active (in the ON mode) in a predetermined cycle greater than the DRX cycle (e.g., DRX cycle 315). In a non-liming example, the CDRX OnDuration windows 523a are active every 160 ms compared to the DRX cycle of about 40 ms.

Power diagram 521b illustrates the UE's power diagram when the UE is in UL silent mode with SID packets and DL silent mode with SID packets. The UE is in the awake mode 521b that includes the CDRX OnDuration window 523b. During the transition to the awake mode 521b and/or during the awake mode 521b, the UE transmits the SR signal 525b for transmitting UL packets using PUSCH 529b. In these examples, the UL packets can include SID packets. Although not shown, the UE can receive an UL grant message before transmitting the UL packets using PUSCH 529b. Additionally, during the transition to the awake mode 521b and/or during the awake mode 521b, the UE can receive message 527b indicating that the base station is to send DL packets. In these examples, the DL packets can include SID packets. As discussed above, according to some aspects, the message 527b can include a wake up signal (WUS). In some examples, one or more bits in the WUS can be set to the first value (e.g., “1”) to indicate that DL packets are to be transmitted from the base station to the UE. In some aspects and as discussed above, the CDRX OnDuration window 523b is active (in the ON mode) in a predetermined cycle greater than the DRX cycle (e.g., DRX cycle 315). In a non-liming example, the CDRX OnDuration windows 523b are active every 160 ms compared to the DRX cycle of about 40 ms.

Power diagram 521c illustrates the UE's power diagram when the UE is in UL silent mode with SID packets and DL silent mode. In this example, in the DL silent mode no SID packets are received. The UE is in the awake mode 521c that includes the CDRX OnDuration window 523c. During the transition to the awake mode 521c and/or during the awake mode 521c, the UE transmits the SR signal 525c for transmitting UL packets using PUSCH 529c. In these examples, the UL packets can include SID packets. Although not shown, the UE can receive an UL grant message before transmitting the UL packets using PUSCH 529c. Additionally, during the transition to the awake mode 501c and/or during the awake mode 521c, the UE can receive message 527c indicating that the base station does not send any DL packets. As discussed above, according to some aspects, the message 527c can include a wake up signal (WUS). In some examples, one or more bits in the WUS can be set to the second value (e.g., “0”) to indicate that no DL packets are to be transmitted from the base station to the UE. In some aspects and as discussed above, the CDRX OnDuration window 523c is active (in the ON mode) in a predetermined cycle greater than the DRX cycle (e.g., DRX cycle 315). In a non-liming example, the CDRX OnDuration windows 523c are active every 160 ms compared to the DRX cycle of about 40 ms.

FIG. 5C illustrates an exemplary power diagrams 540 for a UE in an UL silent mode, according to some aspects of this disclosure.

Power diagram 541a illustrates the UE's power diagram when the UE is in UL silent mode and DL active mode. In these examples, the UE has no UL packets (including SID packets) to transmit. The UE is in the awake mode 541a that includes the CDRX OnDuration window 543a. During the transition to the awake mode 541a and/or during the awake mode 541a, the UE can receive message 547a indicating that the base station is to send DL packets. As discussed above, according to some aspects, the message 547a can include a wake up signal (WUS). In some examples, one or more bits in the WUS can be set to the first value (e.g., “1”) to indicate that DL packets are to be transmitted from the base station to the UE.

Power diagram 541b illustrates the UE's power diagram when the UE is in UL silent mode and DL silent mode with SID packets. In these examples, the UE has no UL packets (including SID packets) to transmit. The UE is in the awake mode 541b that includes the CDRX OnDuration window 543b. During the transition to the awake mode 541b and/or during the awake mode 541b, the UE can receive message 547b indicating that the base station is to send DL packets. In some examples, the DL packets can include SID packets. As discussed above, according to some aspects, the message 547b can include a wake up signal (WUS). In some examples, one or more bits in the WUS can be set to the first value (e.g., “1”) to indicate that DL packets are to be transmitted from the base station to the UE. In some aspects and as discussed above, the CDRX OnDuration window 543b is active (in the ON mode) in a predetermined cycle greater than the DRX cycle (e.g., DRX cycle 315). In a non-liming example, the CDRX OnDuration windows 543b are active every 160 ms compared to the DRX cycle of about 40 ms.

Power diagram 541c illustrates the UE's power diagram when the UE is in UL silent mode and DL silent mode. In these examples, the UE has no UL packets (including SID packets) to transmit and the base station has no DL packets (including SID packets) to transmit to the UE. During the transition to the awake mode 541c and/or during the awake mode 541c, the UE can receive message 547c indicating that the base station has no DL packets to send. As discussed above, according to some aspects, the message 547c can include a wake up signal (WUS). In some examples, one or more bits in the WUS can be set to the second value (e.g., “0”) to indicate that no DL packets are to be transmitted from the base station to the UE. After receiving the message 547c, the UE can transition from the awake mode 541c to the sleep mode. Therefore, the UE can save power by transitioning to the sleep mode earlier than the transitions in power diagrams 541a and 541b (or power diagrams 511a-511c and/or 521a-521c). In these examples, the UE does not starts its DRX on duration timer in response to the message 547c indicating that no DL packets are transmitted by the base station and the determination that the UE does not have UL packets to transmit to the base station.

According to some aspects, the UE and/or the base station can determine voice state transition between the silence mode (e.g., the silence mode with SID packets or the silence mode with no packets) and the active mode. In some implementations, and on the local side, the UE can be configured to detect the voice state transition between the silence mode and the active mode for UL transmission to the base station. Additionally, or alternatively, the base station can detect the voice state transition between the silence mode and the active mode for DL transmission to the UE.

In some implementations, the UE (for UL transmission) and/or the base station (for DL transmission) can detect the voice state transition between the silence mode and the active mode by examining their buffer(s) (e.g., their voice packet buffers). In some examples, the UE and/or the base station can use Real-time Transport Protocol (RTP) layer to detect the voice state transition between the silence mode and the active mode. Each voice packet can have a mode (e.g., an audio mode) to indicate whether that voice packet is an SID packet (e.g., the mode is set to SID) or the voice packet is associated with a user speaking (e.g., the mode is set to active code rate). Based on this mode, the UE and/or the base station can determine whether the voice state transition between the silence mode and the active mode has occurred and can determine what kind of packet the voice packet is.

In some implementations of the local side determination, the UE and/or the base station can use layer 2 (L2) to detect the voice state transition between the silence mode and the active mode. For example, the UE and/or the base station can use the size of the voice packets to detect the voice state transition between the silence mode and the active mode. For example, a voice packet associated with a user speaking (e.g., a Packet Data Convergence Protocol (PDCP) Service Data Unit (SDU), an IP packet, or the like) can have a different size than an SID packet. In a non-limiting example, the voice packet associated with a user speaking can have a size about 121 bytes for a 24.4 kbps code rate and the SID packet have a size of about 66 bytes. Other sizes can be used and the aspects of this disclosure are not limited to these examples. In these examples, different traffic can be on different logical channels. The UE and/or the base station can determine that their packets are voice packets based on the logical channel identifier (ID) on which the packets are received. In other words, by examining the logical channel ID of the packets, the UE and/or the base station can determine that the packets are voice packets.

In some examples, the UE and/or the base station can use the interval between the arrivals of the voice packets to detect the voice state transition between the silence mode and the active mode. For example, the voice packet arrival interval in the active mode can be smaller than the voice packet arrival interval in the silence mode. In a non-liming example, the voice packet arrival interval in the active mode can be about 20 ms or 40 ms, and the voice packet arrival interval in the silence mode can be about 160 ms. Other arrival intervals can be used and the aspects of this disclosure are not limited to these examples. In some examples, the UE and/or the base station can measure the voice packet arrival interval and compare the measured interval with a silence-threshold (e.g., 100 ms). If the measured interval is greater than the silence-threshold, the UE and/or the base station can detect the silence mode. If the measured interval is less than or equal to the silence-threshold, the UE and/or the base station can compare the measured interval with an active-threshold (e.g., 60 ms). If the measured interval is less than the active-threshold, the UE and/or the base station can detect the active mode. In these examples, different traffic can be on different logical channels. The UE and/or the base station can determine that their packets are voice packets based on the logical channel identifier (ID) on which the packets are received. In other words, by examining the logical channel ID of the packets, the UE and/or the base station can determine that the packets are voice packets.

In addition to, or alternatively to, the local side methods for detecting the voice state transition between the silence mode and the active mode discussed above, the base station can also detect the voice state transition between the silence mode and the active mode for UL transmission from the UE to the base station (e.g., remote side detection).

In the remote side detection methods, the base station can predict the voice state transition between the silence mode and the active mode for UL transmission from the UE to the base station based on previous packets that the base station has received from the UE. In the remote side detection methods, the base station can use a message (e.g., the RRC message) to signal to the UE whether skipUplinkTxDynamic is ON or OFF. In some examples, the skipUplinkTxDynamic determines whether the UE supports skipping of UL transmission for an uplink grant indicated on PDCCH if no data is available for transmission. The base station's remote side detection method can be different depending on whether the skipUplinkTxDynamic is ON or OFF.

In some implementations, where the skipUplinkTxDynamic is OFF, the base station can monitor a MAC (Medium Access Control) PDU (Protocol Data Unit) of a voice packet that the base station receives from the UE and can determine whether a logical ID (e.g., lc_id) of the MAC PDU is assembled (e.g., is absent or present). According to some aspects, if the logical ID of the MAC PDU is absent for a number of times (e.g., for a number of MAC PDUs), the base station can determine that the UE has entered into the silence mode from the active mode. In these examples, the base station can monitor the MAC PDUs, determine a number of consecutive MAC PDUs that do not have the logical ID, and compare the determined number with a threshold. If the number of MAC PDUs with no logical ID is equal to or greater than the threshold, the base station can determine that the UE has entered into the silence mode from the active mode. If the logical ID of the MAC PDU is present (or changes from the absent to present), then the base station can determine that the UE has entered into the active mode from the silence mode.

In some implementations, where the skipUplinkTxDynamic is ON, the base station can monitor PUSCH decoding results, and can determine whether pre-scheduled PUSCH is Discontinuous Transmission (DTX). In some examples, the DTX is a method of momentarily powering-down, or muting, the UE when there is no voice input to the UE. Therefore, if the UE does not have any UL packets (e.g., voice packets) to transmit, the base station can detect that no packets are received at the base station during PUSCH. According to some aspects, by counting the number of pre-scheduled PUSCH that do not include packets from the UE, the base station can predict that the UE has entered the silence mode. In other words, the base station can determine that the UE has entered into the silence mode from the active mode if the DTX is detected for a number of times. For example, the base station can determine the number of times the base station detects the DTX and compare the determined number with a threshold. If the determined number of DTX is greater than or equal to the threshold, the base station can determine that the UE has entered into the silence mode from the active mode. In some aspects, the base station can determine that the UE has entered the active mode from the silence mode using similar method discussed above with respect to the case where skipUplinkTxDynamic is OFF.

The base station can use this remote side detection when the pre-scheduling in configured as discussed above. In some examples, if base station is not using the pre-scheduling, the base station can skip the remote side detection. As discussed above, according to some aspects, when the base station has configured the pre-scheduling, the network can configure the CDRX to an ON mode for a UE when the UE is in the speaking mode (UL active mode). Additionally, or alternatively, when the UE is in the UL silence mode, the base station can configure the CDRX mode depending on whether the UE transmits no UL packets or the UE transmits Silence Insertion Descriptor (SID) packets (e.g., background noise). According to some aspects, the base station can use this remote side detection to determine whether the UE is in the speaking mode (UL active mode) or is in the UL silence mode.

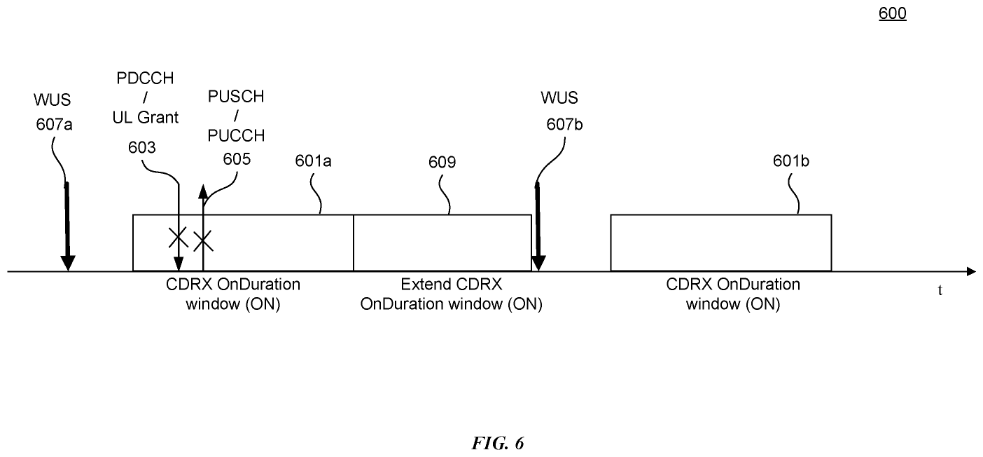

FIG. 6 illustrates an exemplary diagram for enhanced PDCCH monitoring with WUS, according to some aspects of this disclosure. Diagram 600 illustrates the CDRX OnDuration windows 601a and 601b. The UE can be in the awake mode during the CDRX OnDuration windows 601a and 601b to receive DL packets and/or UL grant messages from the base station.

In conventional methods where the WUS scheme is not used, the UE may not know if there would be any PDCCH transmission (e.g., DL packets, UL grant messages, or the like). In these examples, if the UE misses an initial PDCCH during the CDRX OnDuration windows 601a and 601b, the UE may assume that the CDRX OnDuration windows 601a and 601b do not include any PDCCH transmission. Therefore, the UE may not trigger DRX or CDRX related timer and may miss the retransmission of the PDCCH.

By using the messages 607a and 607b (e.g., the WUS), the UE can determine whether to expect any PDCCH transmission. Based on this determination, the UE can extend the CDRX OnDuration window. According to some aspects, after receiving the message 607a, the UE can determine whether any PDCCH transmission will occur during the CDRX OnDuration window 601a. The message 607a can include the WUS. One or more bits in the WUS can be set to the first value (e.g., “1”) to indicate that DL packets/messages are to be transmitted from the base station to the UE during the CDRX OnDuration window 601a. Based on the one or more bits in the WUS set to the first value, the UE knows to expect a PDCCH transmission from the base station. If the UE misses the PDCCH transmission 603 (and/or the UE misses the PUSCH/PUCCH 605) during the CDRX OnDuration window 601a, and the UE does not receiving any other DL transmission during the OnDuration window 601a, the UE know that at least a PDCCH transmission is missing. Therefore, the UE can extend the CDRX OnDuration window 601a by the CDRX OnDuration window 609 to monitor for the retransmission of PDCCH 603. The UE monitors for PDCCH transmission/retransmission during the CDRX OnDuration windows 601a and 609.

In some aspects, the UE is configured to extend the CDRX OnDuration window 601a by the CDRX OnDuration window 609 by extending the UE's active mode. In some examples, the UE is configured to extend the CDRX OnDuration window 601a by the CDRX OnDuration window 609 by extending its DRX on duration timer.

According to some aspects, the UE is configured to extend the CDRX OnDuration window 601a by the CDRX OnDuration window 609 to the next WUS/DCP occasion associated with WUS 607b.

According to some aspects, if the one or more bits in the WUS is set to the second value (e.g., “0”) to indicate tha not DL packets/messages are to be transmitted from the base station to the UE, the will not extend the CDRX OnDuration window.

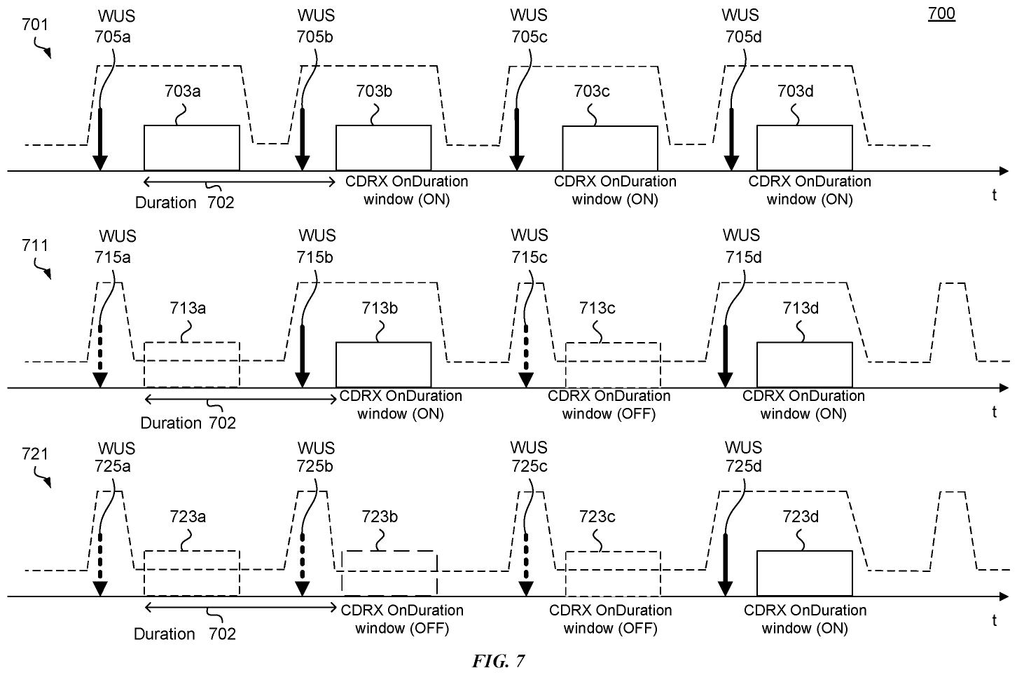

FIG. 7 illustrates an exemplary system for down-sampling CDRX cycle using WUS, according to some aspects of this disclosure. According to some aspects, the UE can bundle multiple voice packets to transmit during each CDRX cycle. Additionally, or alternatively, the base station can configure the CDRX OnDuration windows such that these windows are ON for every N CDRX cycles, where N is a predetermined number. In other words, the base station can configure the CDRX OnDuration windows such that the predetermined number of these windows are OFF between each ON window.

For the UE in the listening mode (e.g., DL active mode), the base station can buffer voice packets and can configure the CDRX OnDuration windows such that these windows are ON for every N CDRX cycles. The base station can send the buffered voice packets in the ON windows.

For the UE in the speaking mode (e.g., UL active mode), the base station can configure the CDRX OnDuration windows such that these windows are ON for every N CDRX cycles and the base station can pre-schedule UL grants for UL transmission for the ON windows. In some examples, the UE does not trigger SR, if both WUS and pre-scheduling is ON.

FIG. 7 illustrates power diagrams 700 for the UE using legacy period for the CDRX cycle and periods for down-sampled CDRX cycles, according to some aspects of this disclosure. Power diagram 701 illustrates the power diagram for the legacy period. Power diagram 701 includes the CDRX OnDuration windows 703a-703d. In this example, the CDRX OnDuration windows 703a-703d are ON and the UE is in the awake mode during the CDRX OnDuration windows 703a-703d. Also, the messages 705a-705d from the base station to the UE indicate that there are DL packets and/or UL grant messages to be sent from the base station to the UE. According to some aspects, the messages 705a-705d include WUS as discussed above. One or more bits in the messages 705a-705d are set to the first value (e.g., “1”) to indicate that there are DL packets and/or UL grant messages to be sent from the base station to the UE. In a non-limiting example, the CDRX cycle can have a duration 702 of about 40 ms. In this example, the voice packets can have a size of about 20 ms. In this example, two voice packets can be transmitted during each CDRX cycle. The aspects of this disclosure are not limited to these examples and other durations and/or sizes can be used.

Power diagram 711 illustrates the power diagram for down-sampled CDRX cycle using WUS. Power diagram 711 includes the CDRX OnDuration windows 713a-713d. In this example, the CDRX OnDuration windows 713b and 713d are ON and the UE is in the awake mode during the CDRX OnDuration windows 713b and 713d. In this example, the CDRX OnDuration windows 713a and 713c are OFF and the UE is in the sleep mode during the CDRX OnDuration windows 713a and 713c. According to some aspects, the messages 715a-715d from the base station to the UE indicate whether there are DL packets and/or UL grant messages to be sent from the base station to the UE. According to some aspects, the messages 715a-715d include WUS as discussed above. One or more bits in the messages 715b and 715d are set to the first value (e.g., “1”) to indicate that there are DL packets and/or UL grant messages to be sent from the base station to the UE. One or more bits in the messages 715a and 715c are set to the second value (e.g., “0”) to indicate that there are no DL packets and/or UL grant messages to be sent from the base station to the UE. By using the messages 715a-715d, the CDRX OnDuration windows can be set to ON or OFF, according to some aspects. In a non-limiting example, the CDRX cycle can have a duration 702 of about 40 ms. In this example, the voice packets can have a size of about 20 ms. In this example, four voice packets can be transmitted during each CDRX cycle that is ON. But the CDRX cycle is ON every other cycle. Therefore, the UE can be in the sleep mode longer compared to the power diagram 701. The aspects of this disclosure are not limited to these examples and other durations and/or sizes can be used.

Power diagram 721 illustrates another power diagram for down-sampled CDRX cycle using WUS. Power diagram 721 includes the CDRX OnDuration windows 723a-723d. In this example, the CDRX OnDuration window 723d is ON and the UE is in the awake mode during the CDRX OnDuration window 723d. In this example, the CDRX OnDuration windows 723a-723c are OFF and the UE is in the sleep mode during the CDRX OnDuration windows 723a-723c. According to some aspects, the messages 725a-725d from the base station to the UE indicate that whether are DL packets and/or UL grant messages to be sent from the base station to the UE. According to some aspects, the messages 725a-725d include WUS as discussed above. One or more bits in the message 725d are set to the first value (e.g., “1”) to indicate that there are DL packets and/or UL grant messages to be sent from the base station to the UE. One or more bits in the messages 725a-725c are set to the second value (e.g., “0”) to indicate that there are no DL packets and/or UL grant messages to be sent from the base station to the UE. By using the messages 725a-725d, the CDRX OnDuration windows can be set to ON or OFF, according to some aspects. In a non-limiting example, the CDRX cycle can have a duration 702 of about 40 ms. In this example, the voice packets can have a size of about 20 ms. In this example, six voice packets can be transmitted during each CDRX cycle that is ON. But the CDRX cycle is ON every third cycle. Therefore, the UE can be in the sleep mode longer compared to the power diagrams 701 and 711. The aspects of this disclosure are not limited to these examples and other durations and/or sizes can be used.

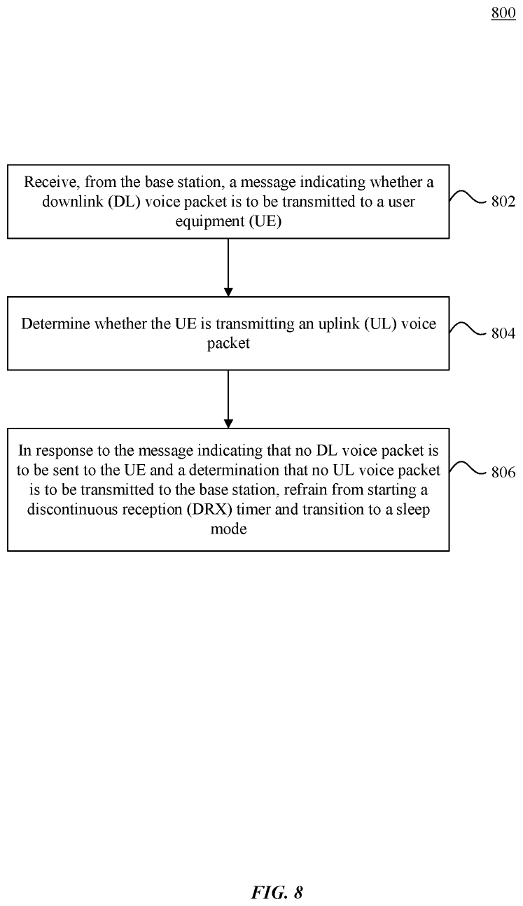

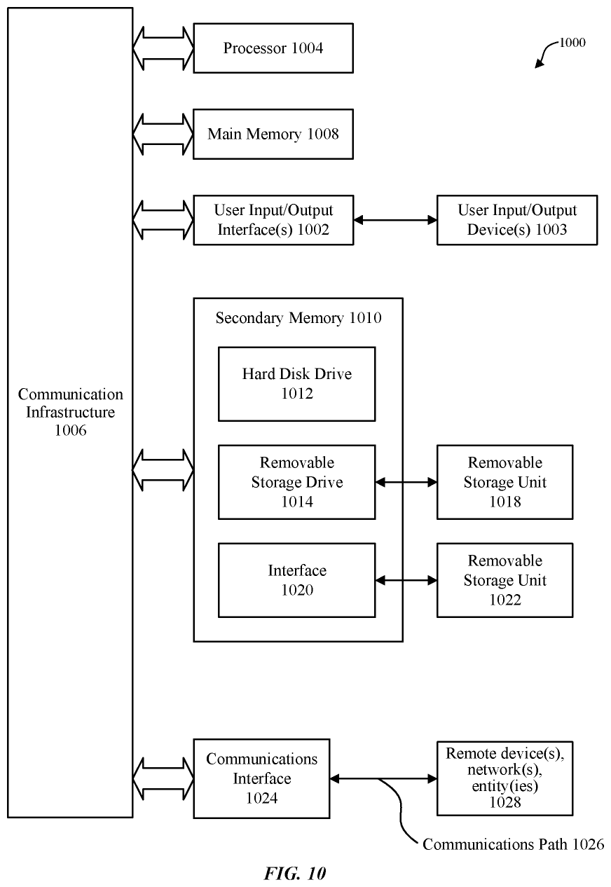

FIG. 8 illustrates an example method 800 for a system (for example, a UE) supporting mechanisms for configuring CDRX and resource allocation, according to some aspects of the disclosure. As a convenience and not a limitation, FIG. 8 may be described with regard to elements of FIGS. 1-7. Method 800 may represent the operation of an electronic device (for example, UE 105 of FIG. 1) implementing mechanisms for configuring CDRX and resource allocation. Method 800 may also be performed by system 200 of FIG. 2 and/or computer system 1000 of FIG. 10. But method 800 is not limited to the specific aspects depicted in those figures and other systems may be used to perform the method as will be understood by those skilled in the art. It is to be appreciated that not all operations may be needed, and the operations may not be performed in the same order as shown in FIG. 8.

At 802, a message is received indicating whether a DL packet (e.g., a DL voice packet) is to be transmitted to the UE. For example, the UE (e.g., UE 105 of FIG. 1A) receives a message from a base station (e.g., base station 101 of FIG. 1A). According to some aspects, the message can indicate whether the base station has DL packets (e.g., DL voice packets) to send to the UE.

As discussed above, according to some aspects, received message can include a WUS. In some implementations, the WUS includes a downlink control information (DCI) format with cyclic redundancy check (CRC) bits that are scrambled by a power saving radio network temporary identifier (PS-RNTI). In some examples, the WUS can have a bit set to a first value (e.g., “1”) to indicate that DL packets are to be transmitted from the base station to the UE. In some examples, the bit of the WUS can be set to a second value (e.g., “0”) to indicate that no DL packet is to be transmitted to the UE.

At 804, a determination is made whether the UE is transmitting an UL packet (e.g., an UL voice packet). For example, the UE can use the local side methods discussed above (or other methods) to determine whether the UE has UL packets to transmit to the base station.

At 806, in response to the message indicating that no DL packet (e.g., DL voice packet) is to be sent to the UE and a determination that no UL packet (e.g., UL voice packet) is to be transmitted to the base station, the UE refrains from starting a discontinuous reception (DRX) timer and transitions to a sleep mode. In these examples, after the UE determines that the UE has no UL packets to transmit to the base station and the base station has no DL packets to transmit to the UE, the UE can transition from the awake mode to the sleep mode earlier than scheduled. In some examples, the UE had transitioned from the sleep mode to the wake mode based on a predetermined schedule (e.g., predetermined CDRX OnDuration windows). For example, the UE transitions from the sleep mode to the wake mode before receiving the message from the base station indicating whether a DL packet is to be transmitted to the UE. During the awake mode the UE receives the message from the base station. Additionally, or alternatively, after the UE determines that the UE has no UL packets to transmit to the base station and the base station has no DL packets to transmit to the UE, the UE will not start is DRX on duration timer. By transitioning to the sleep mode earlier than scheduled, the UE can save power and reduce power consumption.

According to some aspects, method 800 can further include determining that no DL packet is to be transmitted to the UE, determining that the UL packet is to be transmitted to base station, and using an immediate next SR occasion to send an SR signal for transmitting the UL packet. The immediate SR occasion can the SR occasion that is immediately after the receipt of the UL packets at the UE's buffer(s) for UL transmission. In some implementations, the UE can use the local side methods discussed above (or other methods) to determine that the UE has UL packets to transmit to the base station.

According to some aspects, method 800 can further include determining that the DL voice packet is to be transmitted to the UE and determining that the UL voice packet is to be transmitted to base station. Method 800 can further include using an SR occasion immediately before an scheduled CDRX OnDuration window to send an SR signal for transmitting the UL voice packet. In some examples, the UE can select the SR occasion before or immediately before the UE starts its DRX timer (e.g., the DRX on duration timer).

According to some aspects, method 800 can further include determining that the DL voice packet is to be transmitted to the UE and determining that the UL voice packet is to be transmitted to base station. Method 800 can further include using an SR occasion immediately after DCP occasion to send an SR signal for transmitting the UL voice packet.

According to some aspects, method 800 can further include determining that the DL voice packet is to be transmitted to the UE and in response to not receiving the DL voice packet during an scheduled CDRX OnDuration window, extending the CDRX OnDuration window.

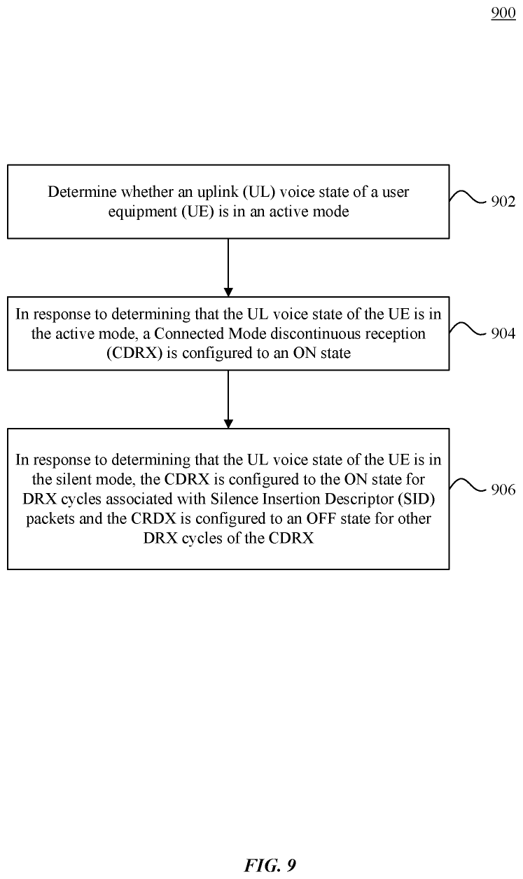

FIG. 9 illustrates an example method 900 for a system (for example, a base station) supporting mechanisms for configuring CDRX and resource allocation, according to some aspects of the disclosure. As a convenience and not a limitation, FIG. 9 may be described with regard to elements of FIGS. 1-7. Method 900 may represent the operation of an electronic device (for example, base station 101 of FIG. 1) implementing mechanisms for configuring CDRX and resource allocation. Method 900 may also be performed by system 200 of FIG. 2 and/or computer system 1000 of FIG. 10. But method 800 is not limited to the specific aspects depicted in those figures and other systems may be used to perform the method as will be understood by those skilled in the art. It is to be appreciated that not all operations may be needed, and the operations may not be performed in the same order as shown in FIG. 9.

At 902, a determination is made whether an UL voice state of a UE is in an active mode. For example, a base station (e.g., base station 101 of FIG. 1A) can determine whether the UL voice state of a UE (e.g., UE 105 of FIG. 1A) is in the active mode (e.g., the speaking mode or the UL active mode) or is in a silence mode (e.g., UL silence mode where no packets are transmitted or UL silence mode with SID). According to some aspects, the base station can determine whether the UL voice state of a UE is in the active mode or in the silence mode using the remote side detection methods discussed above (or other methods).

In some implementations, determining whether the UL voice state of a UE is in the active mode or in the silence mode can include monitoring a plurality of MAC PDUs of a plurality of packets (e.g., voice packets) and determining a number of the plurality of MAC PDUs that do not include a logical identifier (ID). The method can further including comparing the determined number with a first threshold. In response to the determined number being greater than the first threshold, it can be determined that the UL voice state of the UE is in the silent mode.

In some implementations, determining whether the UL voice state of a UE is in the active mode or in the silence mode can include monitoring a MAC PDU of a second packets (e.g., a second voice packet) received after the plurality of packets (e.g., voice packets) and determining that the MAC PDU of the second packet includes a second logical ID. The method can further include determining that the UL voice state of the UE is in the active mode in response to determining that the MAC PDU of the second packet includes the second logical ID.

In some implementations, determining whether the UL voice state of a UE is in the active mode or in the silence mode can include determining a number of pre-scheduled PUSCH occasions during which no UL packets are received at the base station. The method can further include comparing the determined number of pre-scheduled PUSCH occasions with a second threshold. In response to the determined number being greater than or equal to the second threshold, it can be determined that the UL voice state of the UE is in the silent mode.

At 904, in response to determining that the UL voice state of the UE is in the active mode, a CDRX can be configured to an ON mode. According to some aspects, the base station can configure the CDRX to an ON mode for the UE when the UE is in the speaking mode (UL active mode). In some examples, one or more bits in a WUS can be set to the first value (e.g., “1”) to indicate that the CDRX is in the ON mode. In some implementations, configuring the CDRX to the ON mode can include instructing the UE to set up UE's DRX timer (e.g., the DRX on duration timer) and to start UE's DRX timer for the CDRX OnDuration windows for a pre-scheduled CDRX cycle and CDRX OnDuration window duration.

At 906, in response to determining that the UL voice state of the UE is in the silent mode, the CDRX can be configured to the ON mode for DRX cycles associated with Silence Insertion Descriptor (SID) packets and the CRDX can be configured to an OFF mode for other DRX cycles of the CDRX. According to some aspects, when the UE is in the UL silence mode, the base station can configure the CDRX mode depending on whether the UE transmits no UL packets or the UE transmits SID packets. In some implementations the base station can configure the CDRX to the ON mode for SID packets with a predetermined period. Additionally, the base station can configure the CDRX to the OFF mode for other DRX cycles. The base station can configure the CDRX to the OFF mode between the ON mode CDRXs. According to some aspects, the base station can set one or more bits in the WUS can be set to the second value (e.g., “0”) to indicate that the CDRX is in the OFF mode. When the CDRX is set to the OFF mode, the UE does not start it DRX on duration timer, according to some implementations.

Various aspects can be implemented, for example, using one or more computer systems, such as computer system 1000 shown in FIG. 10. Computer system 1000 can be any well-known computer capable of performing the functions described herein such as devices 101, 105 of FIG. 1, and/or 200 of FIG. 2. Computer system 1000 includes one or more processors (also called central processing units, or CPUs), such as a processor 1004. Processor 1004 is connected to a communication infrastructure 1006 (e.g., a bus). Computer system 1000 also includes user input/output device(s) 1003, such as monitors, keyboards, pointing devices, etc., that communicate with communication infrastructure 1006 through user input/output interface(s) 1002. Computer system 1000 also includes a main or primary memory 1008, such as random access memory (RAM). Main memory 1008 may include one or more levels of cache. Main memory 1008 has stored therein control logic (e.g., computer software) and/or data.

Computer system 1000 may also include one or more secondary storage devices or memory 1010. Secondary memory 1010 may include, for example, a hard disk drive 1012 and/or a removable storage device or drive 1014. Removable storage drive 1014 may be a floppy disk drive, a magnetic tape drive, a compact disk drive, an optical storage device, tape backup device, and/or any other storage device/drive.

Removable storage drive 1014 may interact with a removable storage unit 1018. Removable storage unit 1018 includes a computer usable or readable storage device having stored thereon computer software (control logic) and/or data. Removable storage unit 1018 may be a floppy disk, magnetic tape, compact disk, DVD, optical storage disk, and/any other computer data storage device. Removable storage drive 1014 reads from and/or writes to removable storage unit 1018 in a well-known manner.

According to some aspects, secondary memory 1010 may include other means, instrumentalities or other approaches for allowing computer programs and/or other instructions and/or data to be accessed by computer system 1000. Such means, instrumentalities or other approaches may include, for example, a removable storage unit 1022 and an interface 1020. Examples of the removable storage unit 1022 and the interface 1020 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1000 may further include a communication or network interface 1024. Communication interface 1024 enables computer system 1000 to communicate and interact with any combination of remote devices, remote networks, remote entities, etc. (individually and collectively referenced by reference number 1028). For example, communication interface 1024 may allow computer system 1000 to communicate with remote devices 1028 over communications path 1026, which may be wired and/or wireless, and which may include any combination of LANs, WANs, the Internet, etc. Control logic and/or data may be transmitted to and from computer system 1000 via communication path 1026.

The operations in the preceding aspects can be implemented in a wide variety of configurations and architectures. Therefore, some or all of the operations in the preceding aspects may be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, computer system 1000, main memory 1008, secondary memory 1010 and removable storage units 1018 and 1022, as well as tangible articles of manufacture embodying any combination of the foregoing. Such control logic, when executed by one or more data processing devices (such as computer system 1000), causes such data processing devices to operate as described herein.

Based on the teachings contained in this disclosure, it will be apparent to persons skilled in the relevant art(s) how to make and use aspects of the disclosure using data processing devices, computer systems and/or computer architectures other than that shown in FIG. 10. In particular, aspects may operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more, but not all, exemplary aspects of the disclosure as contemplated by the inventor(s), and thus, are not intended to limit the disclosure or the appended claims in any way.

While the disclosure has been described herein with reference to exemplary aspects for exemplary fields and applications, it should be understood that the disclosure is not limited thereto. Other aspects and modifications thereto are possible, and are within the scope and spirit of the disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. In addition, alternative aspects may perform functional blocks, steps, operations, methods, etc. using orderings different from those described herein.

References herein to “one aspect,” “aspects” “an example,” “examples,” or similar phrases, indicate that the aspect(s) described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it would be within the knowledge of persons skilled in the relevant art(s) to incorporate such feature, structure, or characteristic into other aspects whether or not explicitly mentioned or described herein.

The breadth and scope of the disclosure should not be limited by any of the above-described exemplary aspects, but should be defined only in accordance with the following claims and their equivalents.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

What is claimed is:

1. A user equipment (UE), comprising:
a transceiver configured to enable wireless communication with a base station; and
a processor communicatively coupled to the transceiver and configured to:
receive, using the transceiver and from the base station, a message indicating whether a downlink (DL) voice packet is to be transmitted to the UE;
determine whether the UE is transmitting an uplink (UL) voice packet; and
in response to the message indicating that no DL voice packet is to be sent to the UE and a determination that no UL voice packet is to be transmitted to the base station:
refrain from starting a discontinuous reception (DRX) timer; and
transition the UE to a sleep mode.

2. The UE of claim 1, wherein the processor is further configured to transition the UE from the sleep mode to an active mode before receiving the message from the base station.

3. The UE of claim 2, wherein the processor is configured to transition the UE from the sleep mode to the active mode before a scheduled Connected Mode DRX (CDRX) OnDuration window.

4. The UE of claim 1, wherein the message comprises a wake up signal (WUS) having a bit set to a first value to indicate that no DL voice packet is to be transmitted to the UE.

5. The UE of claim 4, wherein the WUS comprises a downlink control information (DCI) format with cyclic redundancy check (CRC) bits that are scrambled by a power saving radio network temporary identifier (PS-RNTI).

6. The UE of claim 1, wherein the processor is further configured to:
determine that no DL voice packet is to be transmitted to the UE;
determine that the UL voice packet is to be transmitted to base station;
use an immediate next Scheduling Request (SR) occasion to send an SR signal for transmitting the UL voice packet.

7. The UE of claim 1, wherein the processor is further configured to:
determine that the DL voice packet is to be transmitted to the UE;
determine that the UL voice packet is to be transmitted to base station;
use a Scheduling Request (SR) occasion immediately before an scheduled Connected Mode DRX (CDRX) OnDuration window to send an SR signal for transmitting the UL voice packet.

8. The UE of claim 1, wherein the processor is further configured to:
determine that the DL voice packet is to be transmitted to the UE;
determine that the UL voice packet is to be transmitted to base station;
use a Scheduling Request (SR) occasion immediately after a downlink control information (DCI) format with cyclic redundancy check (CRC) bits that are scrambled by a power saving radio network temporary identifier (PS-RNTI) (DCP) occasion to send an SR signal for transmitting the UL voice packet.

9. The UE of claim 1, wherein the processor is further configured to:
determine that the DL voice packet is to be transmitted to the UE; and
in response to not receiving the DL voice packet during an scheduled Connected Mode DRX (CDRX) OnDuration window, extend the CDRX OnDuration window.

10. A method, comprising:
receiving, by a user equipment (UE) and from a base station, a message indicating whether a downlink (DL) voice packet is to be transmitted to the UE;
determining whether the UE is transmitting an uplink (UL) voice packet; and
in response to the message indicating that no DL voice packet is to be sent to the UE and a determination that no UL voice packet is to be transmitted to the base station:
refraining from starting a discontinuous reception (DRX) timer; and
transitioning the UE to a sleep mode.

11. The method of claim 10, further comprising transitioning the UE from the sleep mode to an active mode before receiving the message from the base station.

12. The method of claim 11, further comprising transitioning the UE from the sleep mode to the active mode before an scheduled Connected Mode DRX (CDRX) OnDuration window.

13. The method of claim 10, wherein the message comprises a wake up signal (WUS) having a bit set to a first value to indicate that no DL voice packet is to be transmitted to the UE and wherein the WUS comprises a downlink control information (DCI) format with cyclic redundancy check (CRC) bits that are scrambled by a power saving radio network temporary identifier (PS-RNTI).

14. The method of claim 10, further comprising:
determining that no DL voice packet is to be transmitted to the UE;
determining that the UL voice packet is to be transmitted to base station;
using an immediate next Scheduling Request (SR) occasion to send an SR signal for transmitting the UL voice packet.

15. The method of claim 10, further comprising:
determining that the DL voice packet is to be transmitted to the UE;
determining that the UL voice packet is to be transmitted to base station;
using an Scheduling Request (SR) occasion immediately before an scheduled Connected Mode DRX (CDRX) OnDuration window to send an SR signal for transmitting the UL voice packet.

16. The method of claim 10, further comprising:
determining that the DL voice packet is to be transmitted to the UE;
determining that the UL voice packet is to be transmitted to base station;
using a Scheduling Request (SR) occasion immediately after a downlink control information (DCI) format with cyclic redundancy check (CRC) bits that are scrambled by a power saving radio network temporary identifier (PS-RNTI) (DCP) occasion to send an SR signal for transmitting the UL voice packet.

17. A base station, comprising:
a transceiver configured to enable wireless communication with a user equipment (UE); and
a processor communicatively coupled to the transceiver and configured to:
determine whether an uplink (UL) voice state of the UE is in an active mode;
in response to determining that the UL voice state is in the active mode, configure a Connected Mode discontinuous reception (CDRX) to an ON mode; and
in response to determining that the UL voice state is in a silent mode:
configure the CDRX to the ON mode for DRX cycles associated with Silence Insertion Descriptor (SID) packets; and
configure the CRDX to an OFF mode for other DRX cycles of the CDRX.

18. The base station of claim 17, wherein the processor is further configured to:
monitor a plurality of Medium Access Control (MAC) Protocol Data Units (PDUs) of a plurality of voice packets;
determine a number of the plurality of MAC PDUs that do not include a logical identifier (ID); and
in response to the determined number being greater than a threshold, determine that the UL voice state is in the silent mode.

19. The base station of claim 18, wherein the processor is further configured to:
monitor a MAC PDU of a second voice packet received after the plurality of voice packets;
determine that the MAC PDU of the second voice packet includes a second logical ID; and
determine that the UL voice state is in the active mode in response to the determination that the MAC PDU of the second voice packet includes the second logical ID.

20. The base station of claim 17, wherein the processor is further configured to:
determine a number of pre-scheduled Physical Uplink Shared Channel (PUSCH) occasions during which no UL packets are received at the base station; and
in response to the determined number being greater than or equal to a threshold, determine that the UL voice state is in the silent mode.
